(19) United States
(12) Patent Application Publication
(10) Pub. No.: US 2013/0140425 A1
(43) Pub. Date: Jun. 6, 2013

(54) DEVICE AND METHOD FOR DEPLOYMENT OF PHOTOSYNTHETIC CULTURE PANEL ARRAY

(71) Applicant: David Shih-Wei Chou, Grand Forks, ND (US)

(72) Inventor: David Shih-Wei Chou, Grand Forks, ND (US)

(21) Appl. No.: 13/757,596

(22) Filed: Feb. 1, 2013

Related U.S. Application Data
(63) Continuation-in-part of application No. 13/715,933, filed on Dec. 14, 2012.
Application No. 13/715,933 is a continuation-in-part of application No. 13/327,686, filed on Dec. 15, 2011.
Application No. 13/327,686 is a continuation-in-part of application No. 13/161,462, filed on Jun. 15, 2011.
(60) Provisional application No. 61/422,184, filed on Dec. 12, 2010.
(60) Provisional application No. 61/355,121, filed on Jun. 15, 2010.

(51) Int. Cl. F16M 13/02

(52) U.S. Cl. CPC F16M 13/022
USPC 248/550; 248/323; 248/324

(57) ABSTRACT

A device and system for growing a photosynthetic culture is provided which employs one or a plurality of vertically disposed photopanels having an inner chamber configured for holding liquid and the photosynthetic culture such as algae. The inner chamber of the photopanels may have a shape that is defined as well as structurally supported by bridging elements. The photopanels with the bridging elements may be formed as stepped cones and pyramids utilizing common recyclable clear plastic sheets and membranes. The bridging elements also serve to increases the surface area to volume ratio of the inner chamber, expand the surface area exposed to light, alter the hydrodynamics within the photopanel as well as distribute light as light guides to facilitate homogenization of light exposure to individual cells. The bridging elements also have features that allow utilization of direct light beams with shallow grazing angles. When deployed with a support system that allows both translation and rotation of the photopanels, the deployed photopanel array functions as a complete optical system capable of dynamic control of sun light exposure to an algae culture to optimize photosynthetic efficiency.

### CROSS REFERENCE TO RELATED APPLICATIONS

This application is a continuation-in-part of U.S. patent application Ser. No. 13/715,933, filed on Dec. 14, 2012, and is a continuation-in-part of U.S. patent application Ser. No. 13/327,686, filed on Dec. 15, 2011, and is a continuation-in-part of U.S. patent application Ser. No. 13/161,462, filed on Jun. 15, 2011, and also claims the benefit of U.S. Provisional Application Ser. No. 61/422,184 filed on Dec. 12, 2010 and U.S. Provisional Application Ser. No. 61/355,121 filed on Jun. 15, 2010. All of these prior filed applications are respectively incorporated herein in their respective entireties by reference thereto.

### FIELD OF THE INVENTION

The disclosed devices and methods herein relate to a system for the deployment of an apparatus for performing light dependent chemical reactions. In some advantageous embodiments, the apparatus is configured as a photobioreactor. The apparatus may be applied to photosynthetic cell cultures, as it is applied to production of biomass as well as carbon dioxide (CO₂) recycling or sequestration and waste water mitigation.

### BACKGROUND OF THE INVENTION

Current human dependence on fossil or petroleum fuel as a limited resource has prompted development of alternative renewable energy sources. Carbon dioxide (CO₂) emitted from the burning of fossil fuel, as a greenhouse gas and primary cause of global warming, adds further urgency. The United States, it is estimated, consumes more than 43 billion gallons per year of diesel fuel for transportation plus a multiple of this amount for gasoline and other oil-based fuels. In effort to provide fuel using resources other than so called fossil or petroleum derived fuels, biodiesel is derived from vegetable oil and animal fats. Corn based ethanol is now blended with gasoline at higher percentages. Current development of biofuels such as ethanol from corn requires extensive amounts of land and water. The use of food stuff in generation of transportation fuel has caused pricing pressure on agricultural commodities.

Photosynthesis converts the solar electromagnetic energy into stored chemical energy in long carbon chains by assembling carbon from carbon dioxide. Microalgae are the most photosynthetically efficient organisms. Algae, as a source of biofuel, have long been studied. The last energy crisis in the 1970's fueled research in alternative energy sources. A substantial amount of knowledge has been amassed by the U.S. Department of Energy's Aquatic Species Program (ASP). Algae may be grown in impaired water. Algae are highly efficient in photosynthesis with amazing rates of replication. Some algae strains can double every 4 to 6 hours. Algae when grown in certain conditions such as nitrogen-deficient culture can synthesize and accumulate fatty acids to levels greater than half of its dry weight. The algal fatty acids or oils are capable of being and currently are refined into jet fuel for the U.S. Navy. However, cultivation systems allowing for scale up of algae culture from laboratory quantities to an industrial scale of production have heretofore been challenging. Conventionally, such algal cultivation systems can be separated into two categories: open vs. closed. Each conventional category has pros and cons.

The open cultivation systems are “open” to the environment and the most common current form can be described as large raceway ponds. Such open ponds are the least expensive to build and operate. As such, open ponds were advocated by the ASP to compete with fossil fuel. However, raceway ponds require high water use due to constant evaporation. Open ponds offer sub-optimal light intensity control. Open ponds are prone to contamination from wild type strains overwhelming the desired cultured strains being propagated. Additionally, this type of open culture, being unprotected, is subject to predators which feed on algae. Large culture ponds could be decimated in a few days by such predators. While large amount of resources are being funneled into designing or genetically modifying algae to improve yield and overcome the above-noted short comings of open ponds, it is unlikely that public opinion would allow the use of genetically altered mutant strains in open systems with the accompanying risk of uncontrollable environmental contamination even though such risk is very small. Geographic limitations such as temperature and solar irradiance as well as land requirement are additional limitations.

Closed systems or photobioreactors are designed to address all of these limitations and concerns of the open pond systems to varying degrees. One of the major challenges is efficient utilization of solar irradiance. Solar irradiance as experienced at the earth's surface is highly variable. The phenomenon of “self shading or self shadowing” further complicates the utilization of solar irradiance. As light penetrates an algal culture, photons are absorbed by chlorophyll, decreasing the light intensity. This “self shading” is exaggerated in high cell concentration culture with high chlorophyll concentration. In fact, light does not penetrate very far at all in ultra-high cell concentration cultures, sometimes just a few millimeters. Optimal light intensity for algal photosynthesis has been demonstrated to be a small fraction of direct bright solar irradiance, i.e. less than 10% for many algal species. An algal culture in an open pond commonly experiences a detrimental superficial culture layer in which the excessively high light intensity of direct solar beam causes photoinhibition, cell damage and possibly cell death. Through “self-shading”, the high “toxic” layer whereby a middle layer of culture experience “optimized” light intensity for algal photosynthesis. Any deeper layer of culture, as light intensity further attenuates, fails to receive sufficient light to drive algal photosynthesis.

Current art of culture systems, open and closed, rely on homogenization of light exposure to individual cells via cell movement in and out of the various light zones: 1) superficial toxic, 2) middle optimal and 3) deep deficient zones. Algal cells may move into the potential toxic superficial layer to absorb photons for only milliseconds to microseconds before leaving such zone so damaging radicals do not build up. Current art of open ponds utilize large paddles to create stirring and current flow and typical closed systems such as tubular systems utilize pumps. Much of the current flow is laminar flow, parallel to the conceptual light zones described above, instead of more efficient turbulent flow in moving cells perpendicular through the light zones. Furthermore, algal movement through the pumps may experience shear injury at higher velocities. Despite the efficiencies gained with current closed systems, in general, photobioreactors are not cost effective to compete with fossil fuels in normal market conditions. The least expensive of the current closed systems are simple plastic bags with little structure. As these batch type cultures grow and chlorophyll content increases, larger and larger proportions of the culture in the middle does not receive enough light for photosynthesis, limiting achievable cell concentrations.

One prior art example of a closed system is that of U.S. Pat. No. 6,509,188 (Trosch) which teaches a photobioreactor having a reactor chamber formed of transparent material and having recesses and projections adapted to increase the reactor surface area with tubular projections and extensions. In industrial production sizes, this type of construction would require thick walls that would be especially required to withstand the weight of a tall water column of a vertically oriented photopanel. The increased material needed to enclose the algae culture significantly increases the cost of such apparatus. There is no strategy provided to address biofouling. Furthermore, there is a lack of dynamic control of available light depending on time of day, weather and seasonal variations. The growth efficiency gained by such photobioreactor is unlikely to be cost effective in completing with fossil fuels.

As such, there exists an unmet need for closed algae culture systems that function as optimized optical systems to harness available natural solar energy such that the gain solar efficiency justifies a reasonable capital and operational cost to compete with crude oil under normal market conditions. Emphasis should be placed on increasing the surface area to volume ratio of a photosynthetic culture more so than just surface area, to facilitate achieving high cellular concentration and maximize efficiency of material use. The surface area of the algae culture may be expanded vertically as a 3 dimensional light collection volume or array. Increased height of a photopanel potentiates shadowing by adjacent photopanels, however, especially with low solar angles whereby lower portions of the photopanel receives insufficient light. An algae culture system with an optimized optical system capable of controlling the amount of exposed solar irradiance and distribute that solar irradiance over an enlarged surface area thereby reducing the light intensity and minimizing the amount of mixing to homogenize light exposure to each individual cell without shading from adjacent photopanels is highly desired and currently unmet.

### SUMMARY OF THE INVENTION

In one embodiment, an apparatus for containing a light dependent chemical process comprises an enclosure defining an inner chamber to hold a liquid medium. The shape of the inner chamber is structurally stabilized in part or in full by bridging elements. In some embodiments, the apparatus is configured as a photobioreactor. The new construct of “hollow trabeculae” as bridging projections of hollow cavities that engages the opposing wall of a photobioreactor or photopanel is leverage to stabilize the utilization of thin film or sheet material to decrease material use requirement. The “hollow trabeculae” resist lateral distracting force of a water column by bridging and engaging the opposing wall, for example, allowing tall vertical photopanels to expand surface area beyond the two dimensional ground. With dense application of the “hollow trabeculae” as cones and or pyramids, for example, the surface area to volume ratio of the photopanel inner chamber is further increased to facilitate achieving high cellular concentration culture and further increase material use efficiency. Modified stair step features incorporate to the side walls of the “hollow trabeculae” yet further increase the surface area to volume ratio. With the differences of refractory index of between air vs. plastic and plastic vs. water, modified stair step features of the “hollow trabeculae” may be designed to trap light through total internal reflection, or to provide light escape angles. “Hollow trabeculae” may thereby also function as light guides to distribute light. The sloping side walls of the “Hollow trabeculae” also function to alter the bubble path and fluid dynamics within the algae culture to facilitate mixing or homogenization of light exposure to individual cells, by creating additional horizontal flow vectors toward and away from the planar surface of the photopanels. As light guides, features of the “hollow trabeculae” can direct more light to areas of expected high cell movement created by the altered fluid dynamics. The “hollow trabeculae” also facilitates utilization of direct sun light with shallow grazing angles that would otherwise be reflected by a flat planar surface. The portion of the bridging hollow cavity that extends beyond the overall plane of the opposing wall facilitate distribution of the shallow grazing angle direct sun light to the panel side that would otherwise not be exposed by 1) directly penetrated light, 2) captured and released light, as well as 3) reflected light with increased light angles for utilization by non-exposed side of adjacent photopanels.

In one embodiment, a photobioreactor has a sufficiently large vertical height and sufficiently small horizontal cross sectional area to establish a nutrient gradient when a nutrient is applied in one end of the photobioreactor. Diffusion of a nutrient may be reduced by the presence of bridging elements in an inner chamber of the photobioreactor by further decreasing the cross sectional area in a simple planar enclosure. One desired nutrient gradient is Nitrogen.

In one embodiment, photobioreactors are deployed in a system comprising one or more supports along which a plurality of photobioreactors or photopanels can independently translate. In this embodiment, the plurality of photobioreactors can translate from a tight configuration with formation of corridors to allow access and maintenance, to subsequent configuration with more even spatial distribution to allow more even solar energy collection. In some embodiments this system also allows rotation of the plurality of the photobioreactors along their vertical axis to control the amount of solar energy exposed to the photobioreactors. The photopanels may rotate to follow the path of the sun though the day sky, maintaining a predominantly parallel orientation to the direct sun beam. This allows efficient utilization of scattered light as well as shallow grazing angled direct sun light just off parallel to avoid overlap and shading from adjacent photopanels in the deployed photopanel array. This strategy may be counter-intuitive, as most if not all current photobioreactors utilizing direct solar irradiance emphasize a perpendicular orientation to maximize solar irradiance.

### BRIEF DESCRIPTION OF FIGURE DRAWINGS

FIG. 1 depicts a typical vertically disposed photopanel of the disclosed system which is tall and thin. “Hollow trabeculae” as key structural elements are represented in the blow up details. The “hollow trabeculae” are represented as conal structures bridging the two faces of the photopanel.

FIG. 2 depicts the process of thermoforming and representative assembly of a typical photopanel.

FIG. 3 depicts the shape of the inner chamber of the photopanel as altered by the “hollow trabecular” conal structures.

FIG. 3A depicts a close-up of interleaved hollow trabecular conal structures.

FIG. 3B shows a cross-section of the inner chamber of FIG. 3.

FIG. 4 depicts a representative rack system from a side view demonstrating translating arms.

FIG. 5 depicts an overhead plan view of a representative rack system with pivoting and translating mechanisms in different modes of operation pursuant hereto.

FIG. 6 shows a typical photopanel of the device herein formed on one or a plurality of segments with endcaps engaged and operatively positioned in a translating pivoting engagement, upright to a sliding rack support.

FIG. 7 is a perspective view of a single segment making up the plurality of segments which will form a photopanel herein.

FIG. 8 depicts the segment of FIG. 7 with one sidewall removed showing the plurality of stepped frusto-conical elements from both sidewalls to engaging the opposite sidewall, as “hollow trabeculae”.

FIG. 9A is an enlarged view of the stepped frusto-conical elements as “hollow trabeculae” from FIGS. 7-8 bridging two opposite sidewall. “Hollow trabeculae” as bridges offer resistance to lateral forces generated by water column weight through higher intrinsic tensile strength instead of compressive strength in the absence of “hollow trabeculae”. The stair steps further increase the surface area of the algae culture.

FIG. 9B is a detailed view of a preferred embodiment of the stepped frusto-conical elements. The stair steps may be rounded and angled sharply in a strategic manner to act as a light guide, channeling light into the central volume and releasing it at the sharp ‘shoulders’ of the elements.

FIGS. 10-12 depict other shapes and configurations for the projections as “hollow trabeculae.” “Hollow trabeculae” may be virtually any shape which allows for the structural integrity and/or enhanced surface area described herein.

FIG. 13 shows a side-lit LED light panel employed for night time irradiation of the lower zone.

FIG. 14 shows the LED light source engaged to the plastic panel side edge as “side-lit”. The emitted light is trapped in the clear plastic panel by total internal reflection until reflected at strategically placed small notches or grids cut into the outer surface of the panel as showing in FIG. 13.

FIGS. 15A-C depict the exterior view of a photopanel of the device.

FIG. 15A depicts a view of the ‘back’ of a photopanel of the device.

FIG. 15B depicts a view of the ‘front’ of a photopanel of the device.

FIG. 15C depicts a close-up view of the ‘front’ of a photopanel of the device.

FIG. 15D depicts a cross-sectional view through a photopanel.

FIG. 16 depicts the engagement surface area whereby cavities and or projections from the front and back sidewalls contact the opposite sidewall thereby bridging the front and back sidewalls forming a “hollow trabeculae”.

FIGS. 17A-C depict the fate of direct sun beams which strike photopanels of an embodiment of the device at a shallow grazing angle.

FIG. 17A depicts the direct entry of light into the central volume or inner chamber of the photochamber of some embodiments of the device.

FIG. 17B depicts light which instead of penetrating through the clear substance of a sidewall is trapped within the substance of the sidewall due to total internal reflection. The trapped light traverses within the clear substance until released into the inner chamber at sharp light escape angles.

FIG. 17C depicts the reflection of light from a photopanel surface at increase angles, wherein said reflected light with increased angle may become available to a photochemical reaction in an adjacent photopanel.

FIGS. 18 A-C depict even spatial distribution of photopanels of some embodiments of the device and the capability of photopanel rotation to avoid shading by adjacent photopanels. The arrays of photopanels are illustrated with the viewer's visual perspective in the same direction as the incident direct sun beam.

FIG. 18A depicts an array of photopanels evenly distributed along the 2 dimensional ground, for even harvest of scattered indirect sun light. There is however significant overlap or shading among panels given direct sun beam with incidence or direction that is the same as the perspective of the viewer's vision. All of the photopanels except the front row have the right side partially shaded by panels in front, with additional lower part of the panel also shaded by the panels in front.

FIG. 18B depicts superimposition of each photopanel at starting position of FIG. 18A to a rotated position of each photopanel in an array of FIG. 18C after a 90° rotation along the vertical axis of the photopanel.

FIG. 18C depicts an array of photopanels each rotated 90° along its vertical axis from FIG. 18A, above, such that the photopanels are still evenly distributed spatially, and direct light paths through the photopanel array are created without overlap or shading.

FIGS. 19A-B depict deployment configurations of some embodiments of the device similar to FIGS. 18 with hanging racks depicted. The capacity to rotate the photopanel to avoid overlap or shadowing by adjacent panels within a deployed array is illustrated.

FIG. 19A depicts a deployment configuration of some embodiments of the device, wherein the photopanels are evenly distributed spatially but substantial overlap of the photopanel is demonstrated in the direction of incident direct light beam, thereby causing shading and uneven light distribution within surface area of each individual photopanel.

FIG. 19B depicts the same even spatial distribution of FIG. 19A, but without overlap or shading. This is simply achieved by rotation of each photopanel along its vertical axis by 45°. Also as a consequence, the direct light beam angle as relates to the face of the photopanel becomes more shallow.

FIGS. 20A-C depict deployment configurations of some embodiments of the device demonstrating a function of translation.

FIG. 20A depicts photopanels deployed in a tight configuration, such that available space between rows of panels is increased, thereby forming a corridor to facilitate access of photopanels, for example by a technician performing maintenance or replacement of a photopanel of the array.

FIG. 20B depicts an alternate view of the photopanels deployed in a tight configuration as in FIG. 20A.

FIG. 20C depicts photopanels deployed in an open configuration, whereby photopanels are more evenly distributed spatially as related to the 2 dimensional ground for more even distribution of available scattered sun light.

### DETAILED DESCRIPTIONS OF THE PREFERRED EMBODIMENTS OF THE INVENTION

The device and method herein disclosed provides a novel means for the cultivation of algae. Possible application includes but not limited to the production of biomass for biofuels, feed stock, fertilizers, nutraceuticals, as well as water treatment and carbon dioxide sequestration.

### Introduction to Photobioreactor Structure

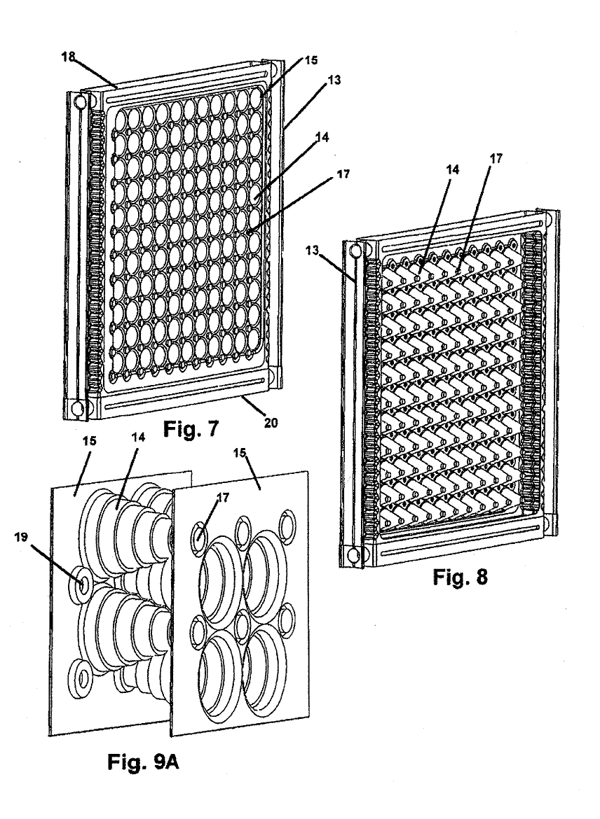

It is one aspect of many embodiments of the invention that photobioreactor side walls may be constructed with thin plastic materials. These materials are usable in this environment even for large photobioreactor sizes by bridging elements provided between opposed walls of the photobioreactor. With this design, cost effective photobioreactors or photopanels can be made with common inexpensive and preferably recyclable material like transparent plastics such as but not limited to Polyethylene Terephthalate (PET) and Polyvinyl Chloride (PVC). The photopanels may be vertically disposed. The photopanels may provide containment of an algal culture with an expanded surface area exposed to light. Furthermore, the algal culture after taking on the shape of the inner chamber of the photopanel may have a high surface area to volume ratio to facilitate high cell concentration. The photopanel may be sufficiently thin and tall for the establishment of different functional zones for cell replication vs. fatty acid synthesis. This is better described as a limited cross sectional area relative to the volume of algae above or below by which the cross sectional area available for diffusion of nutrients, such as nitrogen, to subsequent levels is limited. In some embodiments, these objectives are all achieved by the application of a novel construct referred to herein as “hollow trabeculae.” Some examples of hollow trabeculae can be seen as the cones 14 of FIGS. 7-9. These features can simultaneously perform three functions, each of which is independently usable and valuable. They may bridge enclosure sidewalls to provide mechanical structural support for the shape of the inner chamber such as resisting the distracting lateral forces exerted by a tall water column. They may alter the fluid dynamics within the culture by directing rising bubble paths and resultant cellular movement to facilitate homogenization of light exposure to individual cells. They may distribute light over an expanded surface area as well as direct proportionally more light to area of expected high cell movement to facilitate homogenization of light exposure to individual cells.

The novel construct of “hollow trabeculae” is inspired by nature. Trabeculae are microbridges such as seen in animal cancellous bone. The trabeculae in cancellous bone stabilize the cortical bone outer surfaces with less bony material and increase the surface area (along the surface area of the trabeculae) for supporting marrow cells. The idea of small bridges is applied to give structure to thin plastic membranes and sheets. One manifestation of the trabeculae may be interleaved cones and or pyramids. The bridging elements (which may be hollow cones as stated) can be easily applied to plastic material by the process of thermoforming. Thin plastic sheets or membranes are heated and made to take on the shape of a mold by vacuum and/or positive pressure. The molded thin plastic membranes with studded, repetitive, multi-conal structure may then be fused in an interleaved pattern with an opposing similarly molded plastic membrane or to itself in a clam shape configuration. After the conal apexes are bonded or fused to the opposing side, the formed “hollow trabeculae” bridge the opposing sides, and resist the lateral forces exerted by the weight of the water column. This converts the weaker compression strength of current art to higher tensile strength of plastics. The “hollow trabeculae” are hollow because the cones represent negative space that may be occupied only with air. Climactic conditions and specific algal strain requirements may necessitate thermoregulation of the algae culture. An additional separate outer compartment may be incorporated as one additional layer of transparent material applied to one or both sides of the photopanel to serve as a water bath or jacket. In such case, the “hollow trabeculae” would be filled with circulating water, discontinuous from the algae culture medium. The water jacket could contain solution that further scatters light if desired. Alternatively, the photopanels may be submerged in a large pool of water. The new construct of “hollow trabeculae” provides structural shape and strength, allowing utilization of thin plastic material such as recyclable thermoplastic membranes and sheets instead of thick plates and tubes of current art, substantially decreasing material cost.

Beyond the structural strength function in maintaining the shape of the inner chamber of the photopanel with high surface area to volume ratio by resisting the deformity from the weight of a water column, the “hollow trabeculae” may also serve to distribute light. The “hollow trabeculae” as transparent structures increase the surface area of the inner chamber potentially exposed to light. The intensity of scattered light may be decreased by distributing the amount of light over an enlarged surface area such as that provided by the “hollow trabeculae”. If light otherwise irradiates the circle area of a conal base is allowed to strike the larger surface area of the slanted side walls of the cone, that amount of light or number of photons are now distributed over a larger surface area, thereby effectively decreasing the light intensity. The ratio of surface area expansion is related to the ratio of conal height (H) to the radius (r) of the conal base. For example, a cone with a conal height (H) that equal the diameter of the conal base or twice the radius of the conal base (r), translates to approximately 2.2 times increase in surface area from the circular conal base to the slanted surface area of the conal walls. Similarly, conal height H that equal 3(r) represents expansion of surface area by approximately 3.2 times. Additional surface area expansion can be made with secondary structures on the “hollow trabeculae”. This may represent fine surface irregularities on the conal sides or as regular stair-steps. Conceptually, this could be likened to animal intestinal structure, by which increased surface area is desired for higher nutrient absorption rates. The “hollow trabeculae” or cones, would be analogous to the primary villi, with the additional conal surface irregularity or stair-steps as secondary villi.

The “hollow trabeculae” may further distribute light as a light guide. Portions of light entering the thin clear plastic material of the cones may be trapped due to total internal reflection. This is facilitated by the large difference in index of refraction between air and PET (1.0 vs. 1.5 respectively). The portion of trapped light may be increased by rounded stair step features whereby both sides of plastic is surrounded by air, such as the portions of bridging hollow cavity that extends beyond the plane of the opposing wall near the conal apex. Stair steps along the conal sides may be designed to provide sharp (for example, near) 90° light escape angles into the adjacent aqueous medium with lower index of refraction difference between PET and H2O (1.5 to 1.3 respectively) allowing light into the culture medium. This mechanism is especially useful in guiding direct light beams striking the apex of the cone and adjacent area. With the optimal conal apex geometry, spectral solar beams may be captured despite shallow angle of incidence. Portions of the captured light may be guided to the photopanel side otherwise not directly exposed or turned away from the direct solar beams. Portions of the incident direct spectral solar beams may be reflected with increased angles to facilitate utilization also by the side otherwise turned away or not exposed to direct light of adjacent photopanels in the deployment array. Potential manipulation beyond the geometry of the conal apex may include application of reflective film and or sand blasting to enhance increased trapped and guided light as well as reflected and scattered light. Such manipulations may also be applied strategically in other features of the photopanel.

The “hollow trabeculae” when placed in a tight configuration substantially increases the surface area to volume ratio of the inner chamber and therefore cell culture. The increased light exposed surface area to volume ratio facilitates high cell density algae culture. Light penetration of the algae culture is inversely proportional to the cell density due to “self shading” phenomenon. Due to absorption of light by pigments such as chlorophyll, light penetration of dense algae cultures may only be a few millimeters. A tight “hollow trabeculae” configuration whereby the conal sidewalls are less than one centimeter apart insures high portions of the cell culture would be exposed to sufficient light to drive photosynthesis, especially with limited agitation or cell movement.

A tight “hollow trabeculae” configuration also limits the cross section area to facilitate a more specific objective towards development of algal biofuel is accommodating the mutually exclusive needs for algal cell replication vs. algal fatty acid synthesis and accumulation. In nitrogen-rich culture medium, algal protein synthesis readily occurs. Excess energy is stored in more immediately available energy storage forms such as carbohydrates to drive processes of cell growth and cell replication. In the absence of nitrogen, protein synthesis is limited and cell growth and replication is inhibited. Excess energy from photosynthesis is instead driven towards long term storage in the form of fatty acids. In current production of algal biomass, the whole algal cell is harvested. Cell harvest necessitates cell replication to maintain a stable culture size or total culture cell number. A system that could accommodate both nitrogen-rich environment for cell replication in log-rhythmic phase and nitrogen-depleted environment to drive fatty acid synthesis and accumulation would allow more efficient continuous culture as oppose to limited batch culture. The compartmentalization in relatively small individual photopanels benefits early isolation of problems that may arise such as destructive contamination with viruses, fungi, and eukaryotic predators. The establishment of the two functionally different zones, nitrogen-rich vs. nitrogen-depleted zones is also facilitated by the construct of “hollow trabeculae” which further decrease the cross sectional area available for diffusion as well as providing the overall structural stability of a thin vertically disposed photopanel. A nutrient gradient and establishment of the two different functional zones is established by applying the nutrient only in one end of the photopanel further described under methods.

Another specific objective to optimize photosynthetic utilization efficiency of available solar irradiance is sought by applying the dictum of the Hippocratic Oath, “First do no harm”. The high light intensity of direct spectral solar beam is toxic to algal cells causing photoinhibition, cell damage and possible death, all of which are energetically expensive, lowering the light use efficiency. The novel system seeks to limit direct solar irradiance by spectral sun beams and to more effectively utilize scattered light. Scattered light or indirect natural light is much closer to optimal light intensity for algal photosynthesis. This is largely achieved by simply orienting vertically disposed photopanels substantially parallel to the direct spectral solar beam during day hours, rotating the photopanels with the movement of the sun across the sky. This allows solar beams to evenly penetrate the algae farm to be scattered and reflected by surface treatment of the ground. The top portion of the vertically disposed photopanels would receive atmospherically scattered light as it attenuates towards the ground and the bottom portion of the photopanels would receive predominantly ground scattered light as it attenuates towards the sky. The atmospherically scattered light experienced by the upper portion of vertically oriented photopanel is surprisingly consistent within a smaller light intensity range, regardless of sunny vs. cloudy days. The photopanels' exposure to the high intensity of direct spectral solar beam can be dialed up by angling the photopanels partially off parallel with the solar beam, to match the photosynthetic capacity of the algae culture. This application or strategy may seem simple, but not obvious, as it may be counter intuitive that less light may be more. These principles lead to the deployment strategy and system below. Increased algal culture surface area exposed to light, distribution and reduction of light intensity, as well as the structure to maintain a high culture surface area to volume ratio are all achieved by the application of a novel construct, “hollow trabeculae.”

High light conditions in which the scattered and redistributed light as well as limited direct spectral solar light is still above optimal algal photosynthetic light intensity, the strategy of homogenization of light exposure to each individual cells by cell movement through the various conceptual toxic, optimal and deficient light zones, as previously described is applicable. This mechanism is even optimized by high cell concentration culture because exaggerated “self-shading” causes less light penetration, effectively decreasing the thickness of the first two theoretical zones or layers of light conditions. Algal cells would therefore experience the different zones with little or short displacement. Algal cells could oscillate between light and dark conditions rapidly. The stirring of the cells may be achieved by bubbling, instead of more energy requiring large paddles as in open raceway ponds or fluid pumps in closed tubular systems. CO₂-rich gases such as flue gas from combustion of natural gas or coal may be administered through a sparger at the bottom of the photopanel as a primary nutrient. The gas bubbles serve an additional function of cell agitation as it rises. Since CO₂ utilization for photosynthesis is proportional to available light, increased light source requires more CO₂ delivery or higher bubbling rate, which translates to a higher rate of agitation. In another words, higher light condition could be titrated with higher bubbling rates delivering the higher requirement for CO₂. The predominant turbulent flow caused by bubbling is much more efficient in moving cells perpendicular to the light zones. The slanted side wall configuration of some embodiments of the “hollow trabeculae” alters the bubble path by adding horizontal vectors including towards and away from the outer surfaces of the photopanels as the bubbles rise thereby changing the fluid dynamics within the culture and further facilitate mixing and homogenization of light exposure.

For ease of manufacturing, the photopanel may be made as smaller photopanel component parts that could be assembled into the desired photopanel height. The smaller photopanel components may be manufactured with different surface area expansion ratios and assembled to optimize light intensity for algal photosynthesis relative to the location on the photopanel height as well as geophysical factors. Thinner enclosure materials may be used for upper components of the photopanel. Other manufacturing techniques such as injection molding may also be applied, especially if higher ratios of surface area expansion are desired. Application of “hollow trabeculae” as a disposable and recyclable liner supported by additional more permanent structure support is especially beneficial in certain conditions to decrease operational cost. Such a flexible photopanel system is highly adaptable to accommodate the diversity of photosynthetic organisms and organelles as well as geophysical conditions.

Elements of the photobioreactor such as sampling, and inlet and outlet ports are for basic utility. Their location may be variable, either inserted on the narrow sides on the panel or en-face with the face of the photopanel. The importance of the sparger as well as application of nutrients and supplemental artificial light source will be further discussed below.

The global objective to facilitate and to maintain high cell concentration in an efficient continuous system is achievable by emphasis on increased surface area to volume ratio of the culture with the application of the new construct of “hollow trabeculae”. This contrasts with other systems which just emphasize increased surface area. Such increased efficiency includes reducing the volume of cell culture medium and the material needed to enclose the medium. This represents further reduction of enclosure material cost afforded by the structural strength provided by “hollow trabeculae”. The higher the cell concentration, the higher solar intensity the algal culture could utilize with cell movement. The high surface to volume ratio of the cell culture limits the cell movement required for homogenization of light exposure to individual cells, thereby decreasing possible shear stress as well as facilitating the establishment of a nutrient gradient. Achieving high cell concentration will potentiate cell settling within the vertical photopanel for continuous high cell concentration harvest which lessen the cost of algal separation from the culture media.

Introduction to Deployment Strategy with Sliding/Pivoting Rack System

The global objective of the disclosed novel deployment system for vertically disposed photobioreactors or photopanels is to optimize the solar irradiance exposed to the algal culture by matching the exposed solar irradiance to the photosynthetic capacity of an algal culture. The disclosed deployment system seeks to optimize the following: 1) consistent and uniform distribution of solar energy among the deployed array of multiple photopanels within an algae farm as well as uniform distribution of light within each panel independent of height without overlap or shadowing from adjacent photopanels, 2) mechanism of dynamic light intensity control, and 3) operational practicality. The available solar electromagnetic energy varies tremendously over the hours of the day, as well as with seasonal and atmospheric conditions. The emphasis is on limiting toxic high light intensities as damage to the algal photosynthetic apparatus as well as other cell damage and possible cell death are all energetically expensive. During bright sunny conditions, a control mechanism may be provided to limit the available light quantities exposed to the algal culture to match the maximum photosynthetic rate that the algal culture is capable of utilizing. Consistent uniform distribution of solar energy to the individual photopanels within a deployed array allows monitoring of just a few representative photopanels. If every photopanel needed to be monitored for pH, nitrate, ammonia, oxygen and CO₂, the instrumentation would be prohibitively expensive. With even distribution of solar energy, monitoring of a deployed array of photopanels may be done with minimal sampling of the central vs. peripheral photopanels. The novel deployment strategy must also allow easy accessibility for maintenance, repair or replacement of the photopanels.

By deploying a plurality of tall vertically oriented photobioreactor panels, sun light exposure to algae is distributed to an expanded surface area of a 3 dimensional light collection volume instead of a 2 dimensional plane. The amount of direct sunlight exposure can be controlled and distributed evenly among all photopanels without shading by adjacent photopanels by the capability of rotation and translation of the photopanels. This is made possible by the particular geometry of the “hollow trabeculae” design to utilize direct collimated sunlight with shallow “grazing” angles that would otherwise be reflected off a flat photopanel faces. The function of “hollow trabeculae” as light guides further distribute sunlight evenly throughout the features of a photopanel, as well as direct proportionally more light to areas of expected higher cell movement provided by a rising bubble path. The rising bubble path may be directed by the geometry of the “hollow trabeculae” side walls to facilitate homogenization of light exposure to individual algae cells.

In some embodiments an efficient algae culture platform seeks to match the exposed solar electromagnetic irradiance to the theoretical maximum photosynthetic rate of the algae culture, for example as the summation of the maximal rate of every individual algae cell in the culture. The volume of an algae culture necessitates light penetration to reach deeper cells. This is especially important in high cell concentrations, with prominent “self-shading”. In a relatively static culture, the cells closer to the light exposed surface of the culture experiences more light and the cells furthest from the light exposed surface experience the least amount of light and often none. Furthermore, the most superficial algae cell layer are frequently exposed to direct solar light with supra intensities that causes photoinhibition and possible cell injury. The amount of light exposure to each cell may be homogenized by stirring, or translation of individual cells in and out of light layers, whereby cells may be exposed to supra intensity light only intermittently so accumulation of photoinhibition effects are avoided. The extent or magnitude of stirring applicable is limited however by the shear stress placed on the algae cells by the stirring. A large surface area to volume ratio of an algae culture would decrease the average distance between light and dark conditions. The increased surface area to volume provided by the construct of “hollow trabeculae” would minimize the need for stirring to homogenize light exposure to each cell and limit shear stress on the algae cells.

Solar irradiance at mid-day is substantially greater than early morning and late afternoon. This diurnal variance represents the greatest variance in irradiance and the most consistent. Efficient utilization of all available early morning and late afternoon sun light is emphasized, with over saturating irradiance of mid-day limited. Natural solar electromagnetic energy can be categorized as direct vs. indirect light. Direct solar light beams are collimated with an angle of approximately 0.53°. This is derived from the solar diameter and the distance between the earth and the sun. Indirect light represents photons scattered by interacting with molecules in the earth's atmosphere. The portion of direct vs. scattered light differs with latitude. 90% of incident solar radiation may be direct in bright days at latitudes of 15-35° North. Greater than 45° North, approximately 50% is scattered radiation due to the longer light path through earth's atmosphere. Equatorial latitudes also have less proportion of direct light due to increase scatter from high humidity. The intensity of scattered light during bright sunny days and cloudy days are surprisingly similar and consistent. The scattered light intensity is also much closer to the optimal intensity range for algal photosynthesis than direct irradiance. Scattered light exposure to the algae culture is therefore preferred and the potentially harmful direct solar light beam exposure to the algae culture during mid-day should be minimized. Where small features of the photopanel or algae culture surface area may be exposed to direct solar light beams to increase total light exposure beyond that of available scattered light, these features of small surface area should be at strategic areas where cell movement or mixing is expected to be higher.

### 3 Dimensional Algae Cultivation Platform—Photobioreactor Panel Deployment System

A rack system allows basic organization of the vertical photobioreactor panels as well as controllable complex optimization of photopanel collection of solar energy. The rack system allows full effect of the deployed photopanels as a complete three-dimensional optical system. The rack system is capable of translating the photopanels into an even spatial distribution to harvest the solar electromagnetic irradiance evenly among all photopanels, especially scattered sunlight. Furthermore, the direct sun beams are distributed relatively evenly along all surfaces of each photopanel independent of the height of a particular surface area on a photopanel, i.e. without shading from adjacent photopanels, by the capability of rotation. The rack system with the capability of translation and rotation of the vertically oriented photopanels will leverage the designs of the “hollow trabeculae” as light guides to control the amount of direct sun light with shallow grazing angles desired beyond the available scattered light for algal photosynthesis.

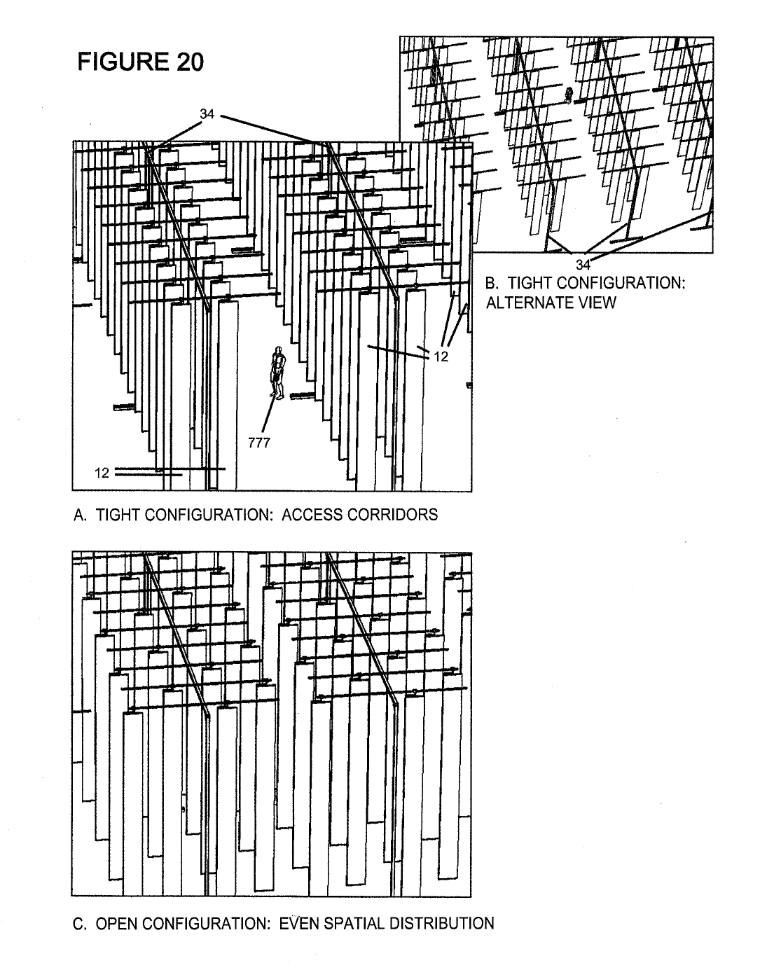

The simple capability of translation allow for even spatial distribution of the photopanels during solar energy collection as well as easy access of the photopanels during maintenance. The tight configuration of the photopanels as in FIGS. 20A and 20B allows formation of corridors to access the photopanels for maintenance. The expanded configuration in FIG. 20C allows more even spatial distribution of the photopanels for even sun light exposure. This evenly distributes scattered light. With tall photopanels, scattered light from the sky would be absorbed and attenuated towards the floor. Scattered light from light strike by direct sunlight reflected off the floor will attenuate towards the sky. This is facilitated in some preferred embodiments by hanging the photopanels 3 to 5 feet off the ground. Typical ground treatment with low absorption coefficient will potentiate the scattering and reflection of the solar beams. A nonlimiting example of such ground treatment includes white high gloss polyurethane on cement. The truncated apices of the conal and pyramidal “hollow trabeculae” allow a greater portion of scattered light penetration through the height of the photopanels to evenly distribute scattered light from above and below.

The capacity for rotation and translation allows optimized utilization of scattered light, and controls the amount of additional light desired by exposure of the photopanels to direct light with shallow grazing angles. When greater light irradiance than that of available scattered light is desired, the photopanels may be rotated just off parallel 5° to 30°, allowing limited amount of direct sun light with shallow grazing angles to be distributed to each photopanel evenly, without shading by adjacent photopanels. Furthermore, the surface area of each photopanel would be relatively evenly exposed, independent of the height position on the photopanel, facilitating the homogenization of light exposure of each algae cell within a tall photopanel by movement. The particular geometry of the modified “hollow trabeculae” allows the efficient utilization of the shallow grazing angled light. If the photopanel surface is flat, the shallow grazing light will simply be reflected away instead of penetrating the algae culture. The “hollow trabeculae” geometry allows the following: 1) direct sun beam light strike where high cell movement occurs to facilitate homogenization of light exposure of each individual cells, 2) penetrate and strike the surface arising from the panel face that is turned away from the direct light and otherwise not exposed to direct light, 3) trap light within the clear substance of the photopanel by total internal reflection and release light towards the central thickness of the panel where light exposure would be limited and cell movement expected to be greatest, and 4) reflect light at greater angles to be collected by adjacent photopanels.

During lower total irradiance of early morning and late afternoon hours, the photopanels may collect all available direct sun beam irradiance as well as the scattered light by rotation slightly off parallel from direct solar beam without causing shadowing of adjacent photopanels. During high mid-day solar irradiance that likely overwhelm the maximum photosynthetic capacity of the algal culture, the total exposed irradiance may be limited by minimizing the direct solar beams by keeping the photopanels parallel to direct solar beams and avoid photoinhibition effects.

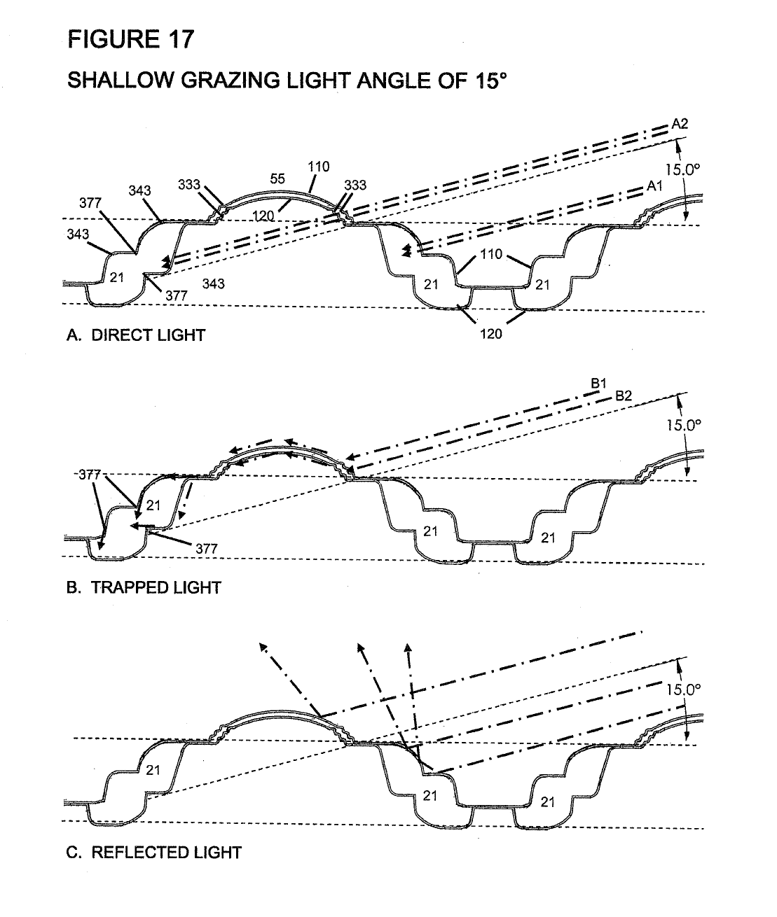

The capacity for the novel construct of “hollow trabeculae” to serve as light guides allows the utilization of such shallow grazing direct light angles of less than 30. Without the specific geometry of the “hollow trabeculae”, the shallow grazing direct light would simply be reflected from a flat surface, instead of being exposed to the algae culture. The “hollow trabeculae” allows direct light exposure of both the membrane or sheet forming the panel face turned slightly into the direct light as well as the membrane or sheet forming the panel face turned slightly away from the direct light as in FIG. 17A. A component of direct light will be trapped by modified stair steps by complete internal reflection, and released through escaped angles at strategic locations typically closer to the middle thickness of the panel as in FIG. 17B. The dome portion of the “hollow trabeculae” accentuate the reflected angle of the shallow direct light for collection by adjacent photopanels via the panel face turned slightly away from the direct light as in FIG. 17C.

The novel construct of “hollow trabeculae” provides 1) structural strength, 2) increased surface area to volume ratio, 3) facilitate flow pattern of bubble path and cell mixing to homogenize algae cell light exposure and 4) light guide with geometry to facilitate utilization of scattered light and shallow grazing direct light. This deployment strategy is counter intuitive to most current algae growth systems that aim to place the photobioreactors perpendicular to the direct solar irradiance to maximize light intensity. This deployment strategy with the ability to translate and rotate the photopanel array leverage the geometry and functions of the “hollow trabeculae” as a complete optical system with dynamic control of light exposure to optimize utilization of solar energy for algal photosynthesis.

The deployment system may be automated by applying a sensor or sensors to track the solar angle and irradiance throughout the day and mechanized translation and rotation of the photopanels controlled by human and or artificial intelligence. Additional sensors may be applied within the photopanel array to monitor amount of scattered vs. direct light. Additional light sensors are also contemplated. In some embodiments the sensor may communicate with an automated device that can configure the photopanels into optimal positions informed by the light conditions.

The deployment system may or may not be enclosed in green house type structure.

Readily available coating technology may be applied to or in proximity to the physical structure or building that encloses the photopanels. UV-absorbing films may be applied to the physical structure or green house. Moveable light diffusion films may also be applied. Consideration for application of such film technology should consider the geophysical location of the algae farm installation. Diffusion films may not be necessary in the equatorial latitudes due to the increase in humidity that causes increased scatter. Similarly, latitudes greater than 40 Degrees also receive significant percentage of scattered light due to a long light path through the atmosphere.

### Methods of Operation

General methods of culture to benefit the structural design offered by the novel construct of “hollow trabeculae” are described in broad conceptual terms to accommodate wide varying culture needs of the diversity of photosynthetic organisms and organelles not limited to eukaryotic microalgae or prokaryotic cyanobacteria. Described methods are meant to illustrate more common application scenarios and not meant to limit other creative applications.

Photosynthetic organisms in aqueous medium are contained within tall photopanels and arranged on sliding and pivoting racks as described above. Autotrophic, heterotrophic, and mixed culture may be applied. Culture may or may not be axenic. Fresh culture medium containing nutrient such as nitrogen (N) and phosphorus (P) are delivered continuously from either the top or bottom ends of the photopanel. The rates of the nutrient delivery, in molar amounts as well as total liquid volume of the fresh medium, are dependent on the photosynthetic activity of the algae culture, the achievable cell concentration for the algal strain and desired rate of harvest. Carbon dioxide (CO₂) rich gas is bubbled through the culture from a sparger positioned at the bottom of the panel. Continuous or semi-continuous algal harvest may be from either end of the photopanel, typically opposite end from the delivery of fresh culture media.

Sparger design and selection of bubble size and rate require careful selection. Delivery of CO₂ rich gases into the photopanel serves multiple purposes. Beyond delivery of CO₂ as a primary nutrient required by photosynthesis, CO₂ also serves as a pH buffer. Bubbling also serves in gas exchange of oxygen (O₂). Oxygen as a by-product of photosynthesis will accumulate. At high levels, O₂ inhibits photosynthesis. Gas exchange of CO₂ and O₂ are in opposite directions: CO₂ out of the bubble and O₂ into the bubble as the bubbles rise towards the top. Gas exchange rates are dictated by mass transfer functions. Gas exchange efficiency or rate relates to bubble size. The higher the surface area (SA) to volume ratio equates to the higher relative gas exchange rate. As such, smaller bubbles with higher SA to volume ratio have relative higher gas exchange rates. Long circular flow stream are to be avoided with a preference for localized turbulent flows. The bubble also serves to agitate the cell culture as described above, causing cell exposure to photons to randomize, especially beneficial in high light conditions with high cell concentrations. The larger the bubble size relates to greater algal cell displacement. Bubble size selection should take into consideration of these two polar benefits. Two separate spargers may be incorporated for better control. Constant agitation by bubbling will also help in limiting biofouling.

High cell concentration culture can be achieved by the structural characteristic of high culture surface area to volume ratio as offered by the tightly packed “hollow trabeculae” novel construct explained above. The high cell concentration culture needs night time support. Because oxygen is a by-product of photosynthesis and often a concern for excessive build up, frequently the need for oxygen in night time algal respiration is forgotten. In low cell concentration cultures or open culture systems, the amount of dissolved oxygen in the culture medium is sufficient for night time respiration of a few cells or there is constant gas exchange with the open environment. In a closed system with ultra-high cell concentration, dissolved oxygen without a constant replenishing source will cause culture collapse.

Night time or dark-hour artificial light may be applied to the bottom of the photopanel. The artificial light will drive photosynthesis in the irradiated portion as a replenishing source of oxygen for algae cells in levels above requiring oxygen for night time respiration. O₂ from the photosynthetically active lower irradiated zone is transported by bubbling. Application of night time artificial light may generate two separate circadian rhythms within a continuous culture. Bubbling with O₂ containing air may be a simple alternative to night time supplemental artificial light. Any energy efficient artificial light source may be utilized such as fluorescence, LED and OLED. LED, a currently available technology, offers substantial benefits. LED may be 5 times more efficient in generating white light. Furthermore, LED can generate only photosynthetically utilized wavelengths so every photon could be utilized. Additional energy saving may be achieved by reliance on red wavelength photons which require less energy to generate than any other color wavelength. LED lighting also has a longer lifespan, upwards of 60,000 hours. A side-lit light panel utilizing a clear material such as polycarbonate is easily incorporated into the photopanel, either in isolation or part of the containment for thermoregulating water bath or jacket. During day time hours when not in use, the side-lit LED light panels are essentially transparent to allow collection of natural scattered light off the ground, so artificial light sources do not have to be moved around daily.

High cell concentration culture helps establish a nutrient gradient within a tall and thin vertically disposed panel. Rate of diffusion is proportional to cross sectional area available between adjacent levels and concentration gradient. A tall and thin photopanel has a relatively small cross-section area at any level relative to the height, or more specifically the volume, above or below the reference level. The cross-sectional area in the novel photopanel design is further reduced by the tightly packed “hollow trabeculae” construct that also maintain the structure shape and dimension, of otherwise widening deformity by the weight of the high water column.

If nitrogen (N) is continuously administered to an algal culture limited to one end of the tall photopanels, there is a limited cross-sectional area for N to diffuse down a nutrient gradient towards N-depleted zones. Furthermore, N is being consumed by a large number of algal cells as it is diffused to adjacent levels. The higher the cell concentration the higher the number of algal cells consuming the nutrient. As a result, a nitrogen-rich zone at the end of nitrogen administration vs. a nitrogen-depleted zone at the opposite end is established. The transitional zone size is proportional by the cross sectional area and inversely proportional to the cell density concentration of the algal culture. The higher consumption rate from higher cell density culture helps to negate the stirring effect from bubbling. An N-rich zone is thereby established to optimize cell replication and an N-depleted zone is established to drive fatty acid synthesis.

In the scenario by which particular desired algal strain is expected to accumulate fatty acid content greater than 50% of its dry weight and the overall individual cell density becomes less than the density of the culture medium, the algal cells plump with fatty acids would slowly float towards the top of the photopanel, where lipid-rich cells would be continuously harvested. Nutrients including N would be administered at the bottom of the photopanel, where the bottom N-rich environment would potentiate cell replication and the top N-depleted environment would drive fatty acid synthesis. The reverse scenario by which fatty acid rich cells have individual cell density greater than the culture medium, the lipid-rich cells would settle to the bottom of the photopanel where harvesting occurs, and nutrients would be administered at the top of the photopanel. The second scenario is expected to be more common. The first scenario is applicable for algal strains selected for or genetically engineered to secrete oil droplets into the culture medium. The secreted oil droplets would accumulate at the top of the photopanel to be easily harvested. This novel photopanel design could accommodate suspension cultures as described above as well as possible adherent cultures that some oil secreting strains may be.

Although constant stirring of the algal culture with bubbling may slow biodeposition on the photopanel, biofouling is inevitable, causing light transmission efficiency of the plastic membrane to deteriorate. The preference for a recyclable material such as PET offers the ultimate option of recycling and reforming. Before recycling, the biofilm remaining on an end-of-life photopanel may be utilized to feed concurrent aquacultures such as mollusks, shrimp and fish. New coating technologies may also be applied to slow the rate of biofouling. Crop rotation of potentially two, three, or four crops of different algal strains could be cultivated with optimized pairing of photopanel surface area characteristics and seasonal variability.

With respect to the above description, before explaining at least one preferred embodiment of the thermoformed vertically disposed system for algae growth herein in detail, it is to be understood that the invention is not limited in its application nor the arrangement of the components or steps set forth in the following description or illustrations in the drawings. The various methods of implementation and operation of the disclosed algae growth system and invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

### Example Embodiments

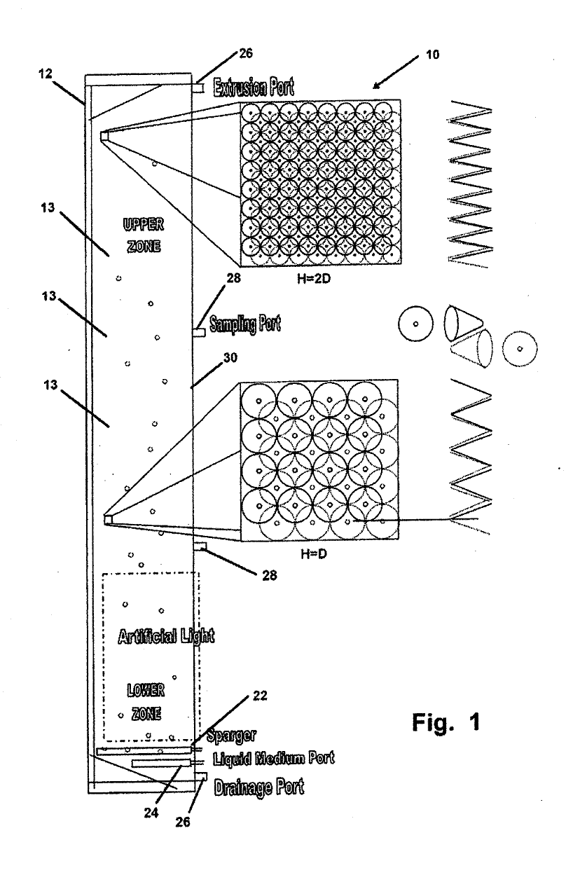

Referring now to the drawings in FIGS. 1-20 wherein similar steps and components are identified by like reference numerals, there is seen in FIG. 1 a typical node of the photobioreactor system 10 herein, showing a vertically disposed placement photopanel 12 formed of engaged membranes or segments 13. The photopanels 12 and engaged segments 13 are of a thin clear plastic material which is formed to the proper dimension and shape by any method which will produce the engaged segments 13 forming the photopanels 12 as described herein. Current preferred dimensions are 8 to 24 feet in height, 1 to 4 inches thick and 2 to 4 feet in width. Preferably, the distance between conal sides is less than one half inch. Greater height, thickness and width are achieved by utilizing thicker plastic sheets. Smaller dimensions are also possible, especially when ease of transportability is desired.

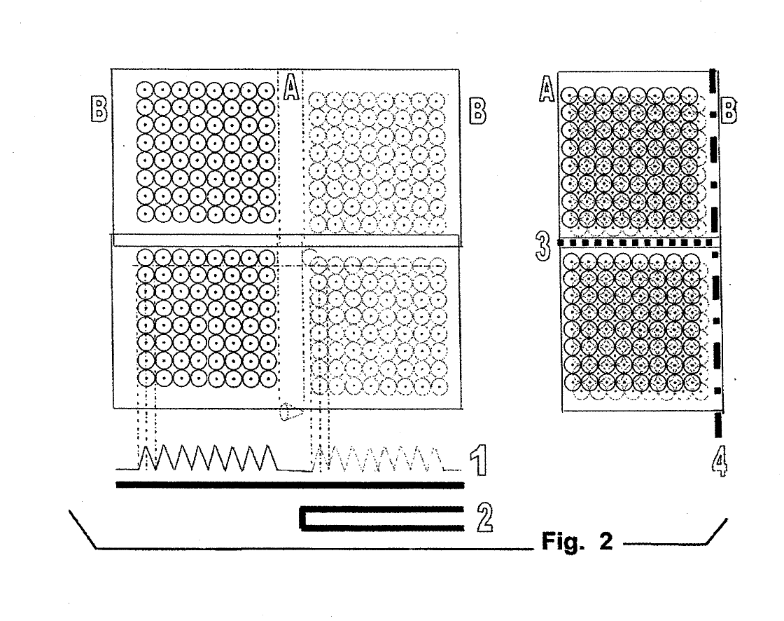

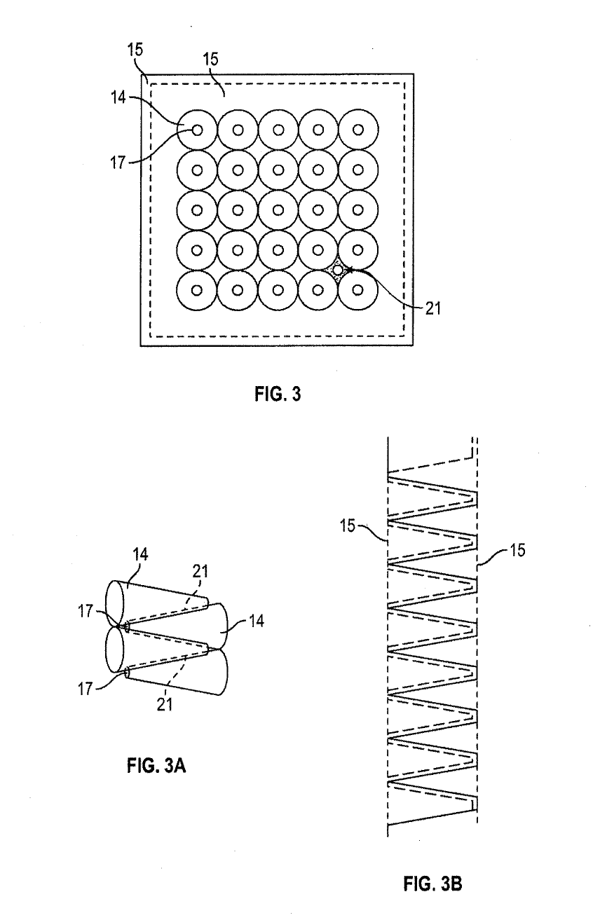

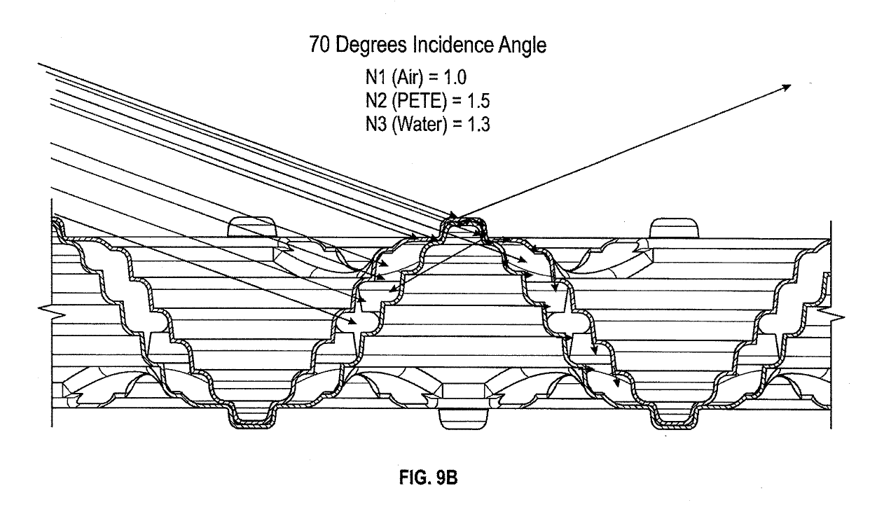

The photopanels 12 may be comprised of a plurality of segments 13 each having sidewalls 15 (such as shown in FIGS. 3 and 9A) employing opposing interlaced projections 14 herein referred to as “hollow trabeculae.” The photopanel segments 13 are preferably shaped by thermoforming with vacuum and or positive pressure assist. The sidewalls 15 take on multiple conal elements 14 by thermoforming. The conal apexes are fused with the opposing sidewall 15 forming a bridge herein referred to as “hollow trabeculae” by ultrasonic or RF heating or adhesive bonding. The “hollow trabeculae” could also be formed near simultaneously with the formation of the projections through twin sheet thermoforming. The distal ends 17 of the projections 14 are configured for a sealed engagement with apertures 19 formed in an opposing sidewall 15 of the formed segment 13. The plastic material should be of conventional inexpensive, preferably recyclable material such as PET and PVC, but higher performance materials may be incorporated for specific functions. The “hollow trabeculae” function as bridges by providing the passage of light between opposite sidewalls and/or by providing structural tensile strength to resist the distracting lateral forces from the weight of the water column. The conal apex or distal end 17 of the projections 14 may be configured with such geometry to gather or trap light, especially shallow incident spectral solar beams (such as shown in FIG. 9B). The stair steps along the side walls of the “hollow trabeculae” 14 may be configured with some smooth rounded curvature corners to trap light around curves in the stepped structure through total internal reflection and also having strategic sharp angles or corners in the stepped structure to direct light escape into the culture medium, thereby acting as a light guide. Different conal characteristic of the “hollow trabeculae” such as height to base diameter ratio and tightness of the conal packing may all be selected according to algal specie or seasonal criteria.

The conal space of the “hollow trabeculae” may be only occupied by air. The inner chamber shape and volume containing the culture medium is limited to the space 21 between the sides of the cones 14 (FIG. 3). When the “hollow trabeculae” are tightly packed, the photosynthetic culture takes on a shape with very high surface area to volume ratio. This ratio may be further exaggerated by additional increase of surface area by the stair step configuration (such as shown in FIGS. 9A and 9B). This high surface area to volume ratio should facilitate ultra-high cell concentration culture.

To further demonstrate the light distribution function of the new construct of “hollow trabeculae” as applied to photobioreactor design, a photon or light ray tracing diagram is included in FIG. 9B to demonstrate the distribution of available direct sun rays in some particular embodiments. Special consideration of light gathering into the clear photobioreactor substrate such as PET at the conal apices of the “hollow trabeculae” is stressed due to the expected application of shallow or high incident angles of solar rays. Designs at the conal apices seek to limit spectral reflection expected with such shallow or high incident angles. This is achieved by decreasing the incident angle from air to PET interface then distributing light through total internal reflection within the PET substrate. Escape angles allow controlled exit of light into the algae culture. Reflected light is expected to be utilized by other photobioreactor panels in the deployment system. Different approaches such as sand blasting surface treatment as well as antireflective coatings may be applied.

The thin plastic segments 13 formed of opposing sidewalls making up the individual photopanels 12, afford the photopanels 12 greatly enhanced structural integrity as well as increased area for algae propagation, by inclusion of these projections 14 (FIGS. 9-11) in a pattern adapted to yield a large surface area for algae propagation. The engagement of the distal ends 17 of the projections 14 to the opposing sidewall 15 provides a means to maintain the dimension of the inner chamber formed between the two sidewalls 15 as well as a means to enhance the lateral load carrying ability of the photopanels 12 allowing vertical disposition and use. Without this engagement between the projections 14 and opposing sidewall 15, the photopanels 12 would be subject to deformation of the inner chamber between the sidewalls 15 as well as bending from lateral load forces when the thin walled photopanels 12 are employed in substantially vertical positions.

With the hollow trabeculae (for example) as bridging elements, thin plastic sheets or even films can be used as the enclosure sidewalls. Advantageously, the thickness of the plastic enclosure walls may be less than 0.25 inches. Plastic walls of less than 0.125 inch thick have been found suitable in many implementations, sometimes less than 0.060 inches. In some embodiments, it is possible to use photobioreactor panel segments from plastic of different thicknesses. Near the top of the photopanel, the thinnest plastic can be used since the weight of the water column is the smallest. Progressively thicker materials can be used for portions of the panel that are closer to the bottom of the photobioreactor. If desired, very thin materials can be used for the photobioreactor enclosure if some structural support is also provided by an external relatively thick plastic or glass enclosure into which the plastic enclosure with the bridging elements is inserted. In this implementation, the photobioreactor may form a liner for a rectangular glass or plastic enclosure. Immersing the thin plastic photobioreactor enclosure in a water bath of similar height can perform the same function.

The shape of the projections 14 may be of any shape suitable to the installation or task, however a frusto-conical stepped configuration as shown in FIGS. 9A and 9B is a particular favored mode of the device 10 as it maximizes the interior surface wall of each sidewall 15 where for algal propagation thereon as well as being structurally quite strong due to the triangular cross section as opposed to a simple elongated member shape.

The complete tall photopanel 12 may be assembled from one or a plurality of interlocking segments 13 to yield the desired height. Each segment 13 is configured with an upper engagement 18 fitting configured for a sealed engagement with a lower engagement 20 fitting of another segment 13 whereby they may be engaged and stacked to form the photopanel 12. The formed photopanel 12 is configured for sealed engagement with a water source to supply necessary fluid to the interior of all engaged segments 13.

The projections 14 or “hollow trabeculae” as conal structures may have different characteristics and may be formed in an infinite number of shapes a few of which are depicted in FIGS. 9-12. As noted the distal ends 17 of the projections 14 engaged an aperture 19 positioned in the opposing sidewall 15 of the segment 13.

While the sidewalls 15 may be formed in any process which yields the correct shapes, thermoforming is currently a favored mode of construction. Molds utilized in the thermoforming process may be built such that each mold may have differing conal height to conal base diameter ratios. The photopanel 12 can then be assembled with a highly customizable series of different trabeculae patterns to optimize light intensity and surface area as relative to available solar irradiance at a particular height. Furthermore the surface of the mold is made irregular with microprotrusions so that the surface of the “hollow trabeculae” provided by the projections 14 in contact with the algae culture is further expanded in terms of surface area in contact.

Specific components as depicted in FIG. 1 such as the sparger 22, liquid medium port 24 and drainage port 26 on the bottom end of the formed photopanel 12, provide fluid flow to the formed photopanel 12 through the engaged plurality of segments 13 forming it. The sparger 22 is operatively connected to a CO₂ and/or other gas supply and provides the communication of gas bubbles into the medium which flow from the lower zone to the upper zone of the photopanel in normal operations. The extrusion of collection port 26 on the top end of the photopanel 12 which provides the connection to remove algae from the upper zone, and the intervening sampling ports 28 where test samples of the medium may be taken, are incorporated into the spine 30 of the photopanel 12 as area denoted as (A) on FIG. 2. The liquid medium port 24 provides the appropriate nourishing liquid to the medium and the drainage port 26 is employed to drain the photopanel 12 when necessary.

The liquid medium port 24, extrusion and drainage port 26 on the ends of the formed photopanel 12, may be interchangeable in part dependent upon culture method and particular culture requirements. The location of the sparger 22 at the bottom of the photopanel 12 is less flexible. These elements may be incorporated to the photopanel along the narrow sides of or en face to the photopanel.

Also shown in FIG. 1 is the configuration of the projections 14 or conal structures which may be varied in terms of a different ratio between conal heights (H) to the circular diameter (D) of the conal base. Two different conal height to base diameter ratios are represented with higher ratio (H=2D) on the upper portion of the panel and lower ratio on the lower portion (H=D). Considering a uniform thickness of the photopanel or constant H, the conal circular base of the lower ratio is represented with circular diameter twice that of the higher ratio.

FIG. 2 depicts the process of thermoforming the sidewalls 15 and representative assembly of a typical photopanel 12. Thin plastic membranes give shape as sidewalls 15, with projections 14 of regular measured conal projections in a tight configuration by thermoforming (1). The plastic membrane forming the sidewalls 15 may be folded like a clam shell or book (2). The width of the spine (A) equals the height of the conal projections 14. The distal ends 17 of the conal projections 14 are fused or otherwise engaged to the opposing sidewall 15 in a registered engagement to form the projections 14 in an interleaved fashion. Each such segment 13 may be assembled with other segments 13 by a sealed engagement of the bottom to top edges of subsequent segments. Once all segments are assembled, the remaining open edge (B) is fused.

The photopanel 12 formed in such a relatively inexpensive fashion with recyclable material is amicable to reforming and replacement approximately every 3 to 6 months. This ultimately solves biofouling and UV degradation of PET. This also allows ease of crop rotation with selection of appropriate algal strain pairing with appropriate seasonal changes as well as optimized “hollow trabeculae” characteristics. Before reforming, the proteinaceous biofouling on old photopanels may be used as feed for simultaneous aquaculture.

The trabecular architecture of the photopanel may be applied to a liner as well as an outer wall component that offers more structural stability. In such application, a disposable or recyclable liner of substantially thinner plastic material would address the issue of biofouling, and a thicker outer component made of UV stable clear plastic may have extended functional life of numerous years. This strategy may offer the greatest cost efficiency.

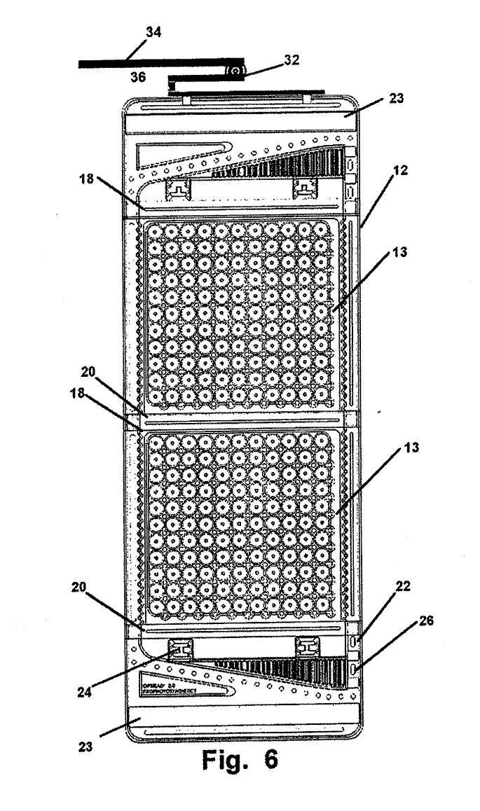

As shown in FIG. 3, the projections 14 extend in opposite directions from the opposing sidewalls 15 forming each membrane 13 and form thin channels 21 there between. The algae culture medium occupies the surface of the interleaved projections 14 in the formed thin channels 21 in each membrane. Fluid and gas in the segments 13 flow from the lower end to the upper end of each such segment 13 and follows this fluid flow path from the lower end of each photopanel 12 (FIGS. 1 and 6) to the upper zone of each photopanel 12. This allows for a constant provision of nourishment to the algae culture occupying the thin channels 21 between the interleaved conal walls of the projections 14.

The most materially efficient and cost effective plastic membrane thickness may be selected. In considering the thickness of the sidewalls 15, consideration is made for the support they must provide, further thinning during thermoform of the projections 14 providing the trabeculae, as well as the tension placed on the segments 13 in the vertical orientation as related to weight of the formed photopanel 12 itself as well as the contained culture therein. The thickness of the sidewalls 15 should be able to adequately support the formed photopanel 12 and its contents and may be calculable based on the strength of the plastic employed or empirically established. Similarly, the thinness of the photopanel 12 is optimized with similar considerations, as the thinness is dictated by the height of the trabecular cones formed by the projections 14.

In addition, the thinness of the photopanel 12 as related to the height of the photopanel 12 may be such that a nutrient gradient can be easily established. The relative cross sectional area of the photopanel with the application of “hollow trabeculae” (FIG. 3B) relative to the volume of culture media above and below is severely limited, thereby restricting diffusion and dispersion of nutrients between levels. By selectively applying a nutrient to only one end of the tall photopanel, a nutrient gradient such as that of a Nitrogen-rich and Nitrogen-depleted zones may be established.

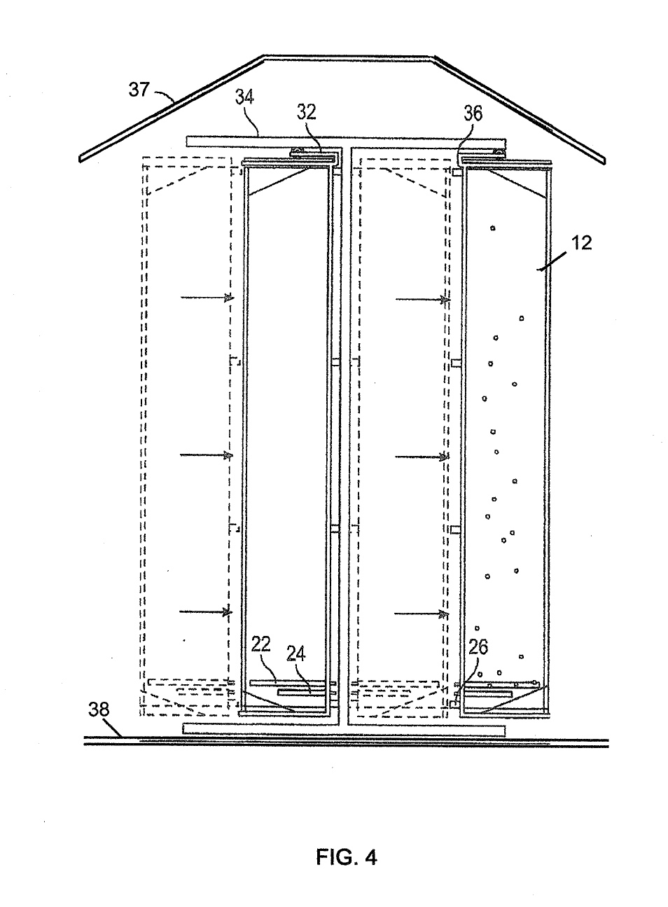

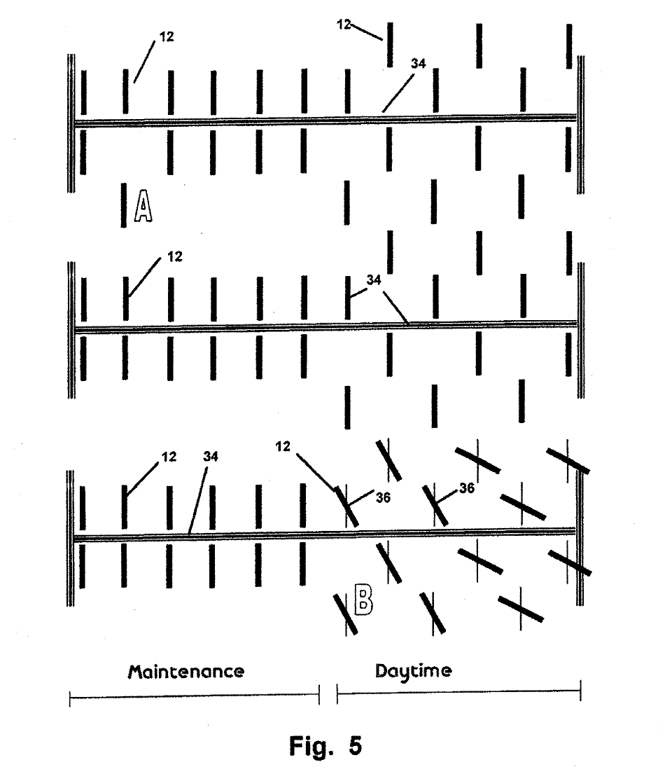

The deployment strategy with rack systems of FIGS. 4-5 are made operative through the employment of engaged arms 32 supported by racks 34. The arms 32 provide a means to translate the photopanels 12 on the sliding engagement with the supporting rack 34 and also to rotate on the pivot 36 engagement with the photopanels 12, are depicted in FIGS. 4 and 5.

The deployment ability afforded by the rack system is shown in FIG. 5 wherein the triple lines represent basic rack structure. The bold short lines (A) represent the width of the hung photopanels 12 as seen from an overhead view. As shown, in a night time configuration labeled “A” of FIG. 5 the noted rack system provides a means to translate the photopanels 12 as a means to facilitate the communication of supplemental artificial light, as well as a means to translate the photopanels to positions for maintenance.

The daytime configuration depicted in section “B” employs the provided means for translation of the photopanels 12, to position the photopanels 12 in alternating and/or angled positions to yield a more uniform distribution to each photopanel 12 of incoming light as shown. The translation and pivoting system thereby operates a means to maximize the positioning of the photopanels 12 for an optimum even communication of incoming daylight. Employing the arms of the translating racks and a pivotal engagement provides a means to angle the photopanels to positions to maintain them substantially parallel to the incoming direct solar beams such as on bright sunny days (B).

Additionally shown in FIG. 4 is the optional roof 37 which may cover the device 10 and operate to diffuse light from the sun. Also depicted is the support surface 38 for the device 10 which may be painted or coated with material adapted to scatter reflected light toward the photopanels 12. The roof 37 and the support surface 37 would be optional enhancements to the performance of the device 10 to users which may be added and adapted for diffusion and scattering ability depending on the terrestrial location of the device 10 and angle of the structure housing the photopanels 12 to the path of the sun thereover.

There is shown in FIG. 6 a typical photopanel 12 of the device 10 herein formed on one or a plurality of segments 13 with endcaps 21 engaged. The upper engagement 18 fitting of the lower positioned segment 13 is configured for a sealed engagement with a lower engagement 20 fitting of the above-positioned segment 13. This allows the photopanels 12 to be assembled to the desired height using one or a plurality of segments 13 which are placed in a stacked sealed engagement. Fluid and gas flow from the sparger 24 and liquid medium port 22 move from an area near the lower engagement 20 of the lowest positioned segment 13 up through all segments 13 until reaching the upper engagement 18 of the highest positioned segment 13 and the endcap 23 engaged therein. The fluid and gas flow through the channels 21 in each segment 13 to maintain the growing environment for algae therein at optimum levels.

For maximizing light transmission and positioning for maintenance, the photopanel 12 is operatively engaged upright to support 32 slidingly engaged to a rack 34 with a pivot 36 providing means to rotate the photopanel 12. Of course those skilled in the art will realize that the sparger and liquid medium port may be combined, and that other configurations might be employed for fluid and gas supplies to the photopanel 12 and such are anticipated within the scope of this application.

FIG. 7 is a perspective view of a single segment 13 making up the plurality of segments 13 which will form a photopanel 12 herein. As shown, both sidewalls 15 are depicted each with projections 14 which engage apertures at their distal ends 17 in the opposing sidewall 15 which provides exceptional structural integrity to each segment 13.

FIG. 8 depicts the segment 13 of FIG. 7 with one sidewall 15 removed showing the plurality of frusto-conical projections 14 which project from both sidewalls 15 to distal ends 17. The depicted distal ends 17 are in all cases sized to engage apertures 19 or other engagement components in the opposing sidewall 15. Those skilled in the art will realize other means to engage the distal ends 17 of the projections 14 may be employed to achieve the exceptional structural integrity herein and such is within the scope of this application.

FIG. 9A is an enlarged view of stepped frusto-conical projections 14 showing the distal end 17 engagement to the apertures 19 in an opposite sidewall 15 and the greatly increased area of surface for algae propagation such a configuration affords the sidewall 15 surfaces, while concurrently providing an exceptional increase in structural strength and integrity.

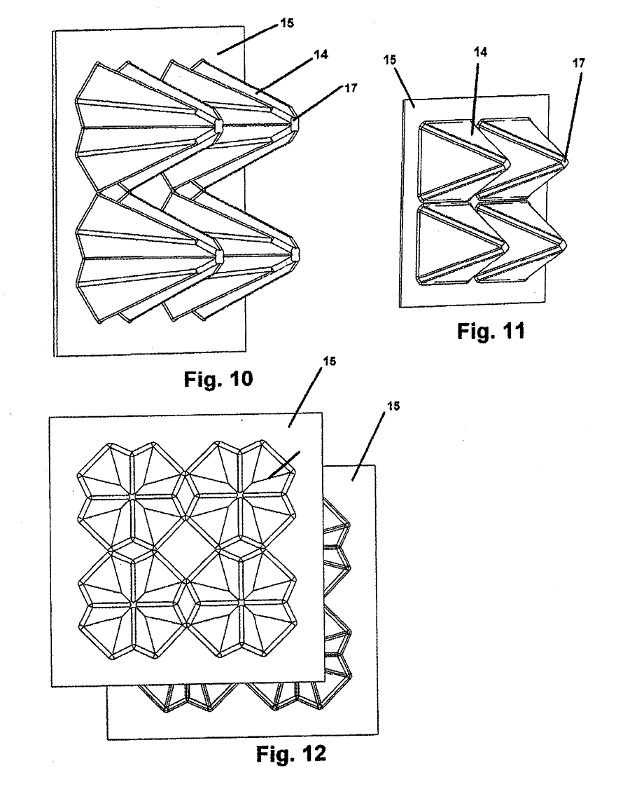

FIGS. 10-12 depict other shapes and configurations for the projections 14 which those skilled in the art will realize may be virtually any shape which allows for the structural integrity and enhanced surface area described herein. However, the stepped frusto conical shape depicted herein in FIG. 9B has advantageous light guiding properties as described above.

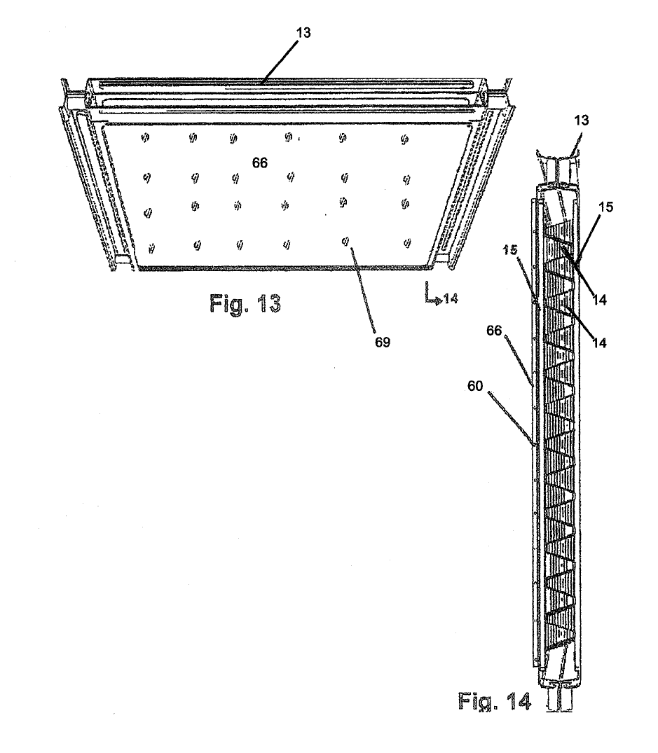

As shown in FIGS. 13 and 14, the system herein additionally may provide means for artificial light transmission to the segments 13 forming the photopanels 12. Currently such artificial light is generated by light emitting diodes (LEDs) 60 positioned about the perimeter edge of a clear plastic panel 66, i.e. “side-lit” LEDs. Light emitted from the side LEDs 60 is trapped by total internal reflection within the panel 66. The internally trapped light is directed towards the inner chamber at specific cutouts or notches 69 formed in the panels 66 by reflection. The LED side-lit clear panel 66 may be separate or incorporated into the main photobioreactor wall. The cutouts or notches 66 does not block any appreciable amount of sunlight or natural light from transmission therethrough and thus allows for full communication of natural light to the medium when LEDs are not in use. Future application of OLED technology is promising.

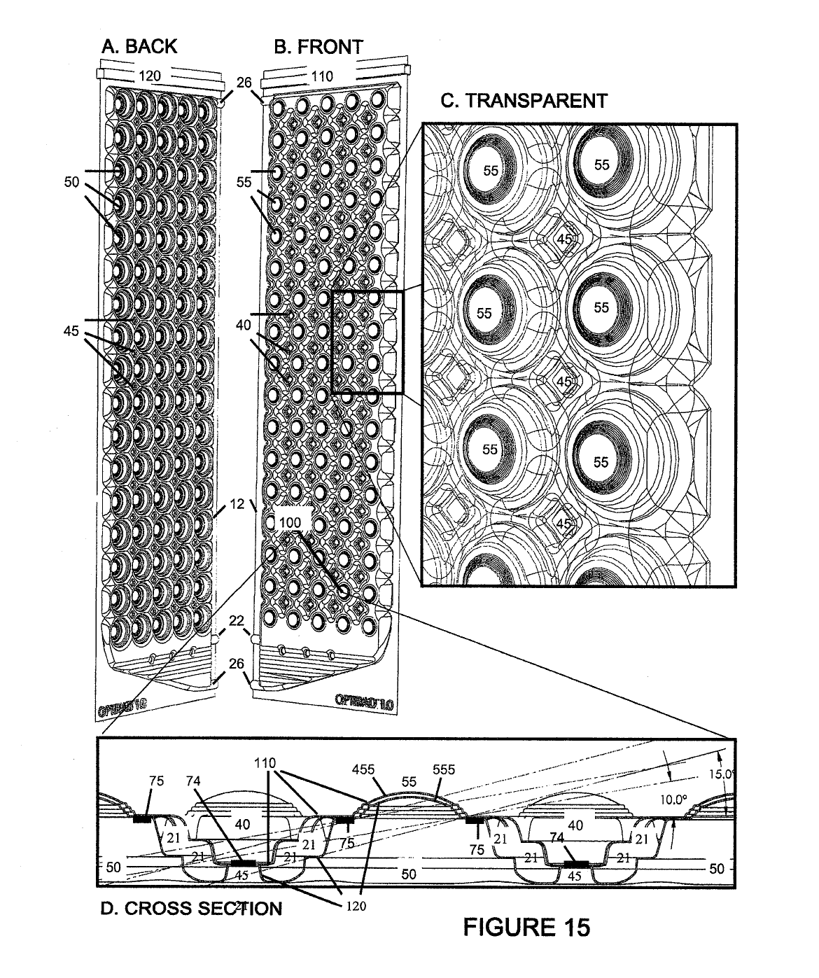

As shown in FIG. 15A, a photopanel 12 is viewed from its ‘back.’ Conduits that facilitate entry or exit of nutrients, lipids, other liquids or algae from the device are indicated at 22 and 26, whereby 22 represents place of insertion for a sparger in this embodiment. Concave indentations or cavities from the vertical plane of the back of the photopanel 50 comprise the base of the conal hollow trabeculae. Between the round bases of the conal hollow trabeculae are smaller diamond shaped indentation 45 which represents the apex of the pyramidal hollow trabeculae.

As shown in FIG. 15B, a photopanel 12 is viewed from its ‘front’ face. Conduits that facilitate entry or exit of nutrients, lipids, other gases, liquids or algae from the device are indicated at 22 and 26. Convex domes that protrude from the plane of the panel at regular intervals are indicated at 55. These domes 55 represent the modified truncated apexes of the conal hollow trabeculae. Diamond shaped indentations or cavitations 40 represents the bases of the pyramidal hollow trabeculae.

As shown in FIG. 15C, the photopanel viewed in close-up from the front is depicted as a transparent line drawing. The tight arrangement of conal- vs. pyramidal-hollow trabeculae projecting from opposite membrane walls is illustrated. The dome shaped truncated apex of the conal hollow trabeculae 55 and the diamond shaped apex of the pyramidal hollow trabeculae are labeled.

FIG. 15D shows a diagonal cross-sectional view, 100 through the photopanel of 15A. The Front sidewall, 110 and back sidewall, 120, are shaped by the pyramidal hollow trabeculae 40 and conal hollow trabeculae 50. As delineated by thickened lines, the two sidewalls contact at a disc-shaped area of engagement 75 surrounding the convex dome 55 of the conal hollow trabeculae 50 and a diamond shaped area of engagement 74 of the pyramidal hollow trabeculae 40. A continuous inner chamber 21 with high surface to area ratio is thereby formed. Of note, air separates the two membrane layers 455 of 110 and 555 of 120 at the convex dome.

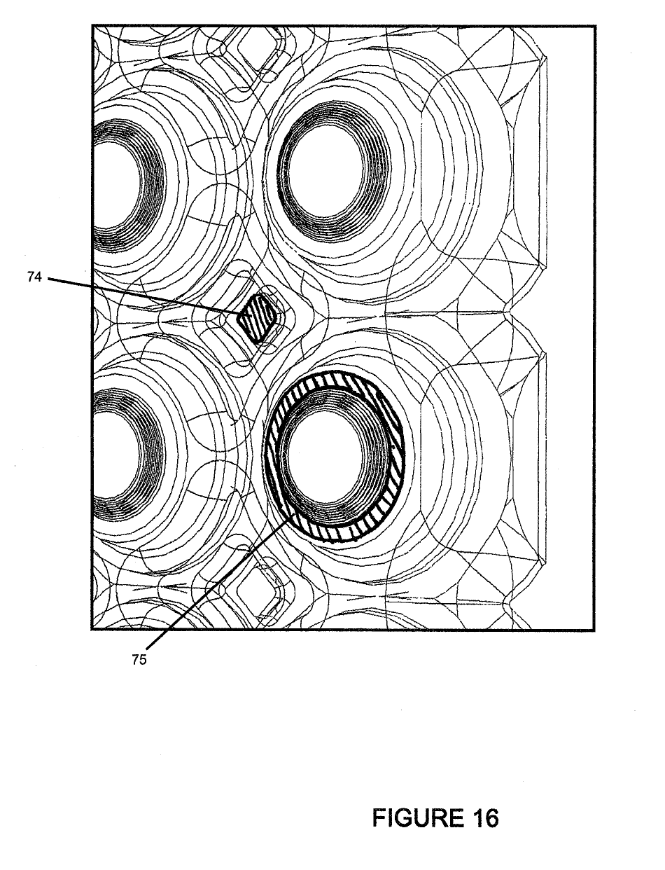

FIG. 16 shows a close-up view of FIG. 15C. The engaging disc-shaped contact area of the conical hollow trabeculae 75 and the diamond shaped contact area of the pyramidal hollow trabeculae 74 are designated with hash lines. The engagement area illustrated represents simple planar areas essentially parallel with the overall vertical planar surface of the photobioreactor panel. The engagement area may be strengthened with more complex multiplanar shapes. In some embodiments the front and back sidewalls may be permanently fused at the engagement area, for example through a twin sheet thermoforming process that near simultaneously form the shapes of the sidewalls as well as fusion of the two side walls into a single piece. In some embodiments, the front and back sidewalls are reversibly bound at the engagement area, for example by ‘snapping together’ at the contact points using a zero or negative draft in the thermoforming process. In some such embodiments the sidewalls may be repeatedly bound and separated, so that, for example, the interior of a photopanel may be accessed without destruction of the photopanel. This allows the application of disposable or recyclable inner liner of considerable thinness and more permanent thicker outer components to further decrease operational cost. Such a reversible mechanism likely requires engagement planes substantially more perpendicular to the vertical plane of the photobioreactor panel.

FIG. 17 is an enlarged and simplified version of the photopanel cross section in FIG. 15D. Specific features of the hollow trabeculae designed to utilize direct sun light with shallow grazing light angles are highlighted. Stair step features are incorporated into both the conal and pyramidal hollow trabeculae as light guides. A series of rounded stair steps 333 at the margins of the dome 55 facilitate penetration of shallow angled light as well as capture through total internal reflection, due to the high differential between refractory indexes of air (1.0) and PET (1.5). Additional rounded stair steps 343 changes the direction of the entrapped light. Sharp angles 377 offers light escape angles directing light into the culture media or inner chamber 21 with lower refractory index differential between PET (1.5) and water (1.3). These escape angles 377 are strategically placed toward the central thickness portion of the photopanel, where rising bubble flow and cultured cell movement is expected to be the greatest. FIGS. 17 A-C depict the various fates of beams of light striking the photopanel. For illustrative purposes, a grazing light angle of 15° is shown, although the utility of the photopanels is not limited to this angle of incident light.

FIG. 17A depicts the direct penetration of light beams or light rays into the inner photochamber 21 of some embodiments of the device. A1 demonstrates light beams directly penetrating into inner chamber 21, by simply penetrating the front sidewall or membrane 110. A2 demonstrates light beams that directly penetrates the portion of the rounded stair steps 333 of both front 110 and back 120 sidewall membranes that is relatively perpendicular to the shallow light beams, followed by direct penetration of the back sidewall or membrane 120 again, near the central thickness of the photopanel where cell movement is expected to be the greatest.

FIG. 17B depicts shallow light beams trapped within the substance of the clear membrane sidewall, guided and distributed to be release at strategically placed light escape angles. B1 demonstrates a shallow light beam that enters the substance of the front sidewall membrane 110 and trapped within the PET substance because of total internal reflection. The trapped light would traverse within the side wall substance and released at sharp escape angles 377 into the inner chamber with closer refractory index difference of 0.2 between PET and water as opposed to 0.5 between PET and air. B2 demonstrates a shallow light beam that may penetrate and exit the front side wall membrane 110 but trapped by the curved stair step feature formed from the back sidewall membrane 120, also released into the inner chamber at area of expected high cell movement or mixing.

FIG. 17C depicts the reflected shallow light beams off the front sidewall of the photopanel of the device. The reflected light beams have steepened angles, easily collected by the back side wall 120 of adjacent deployed photopanels that is turned away from the direct sun beams. Without the features described in FIG. 17, a flat planar photopanel would simply reflect light beams with shallow angles such as 15°. Such reflected light beams would maintain relative shallow angles also reflected off subsequently exposed panels in a deployment array.

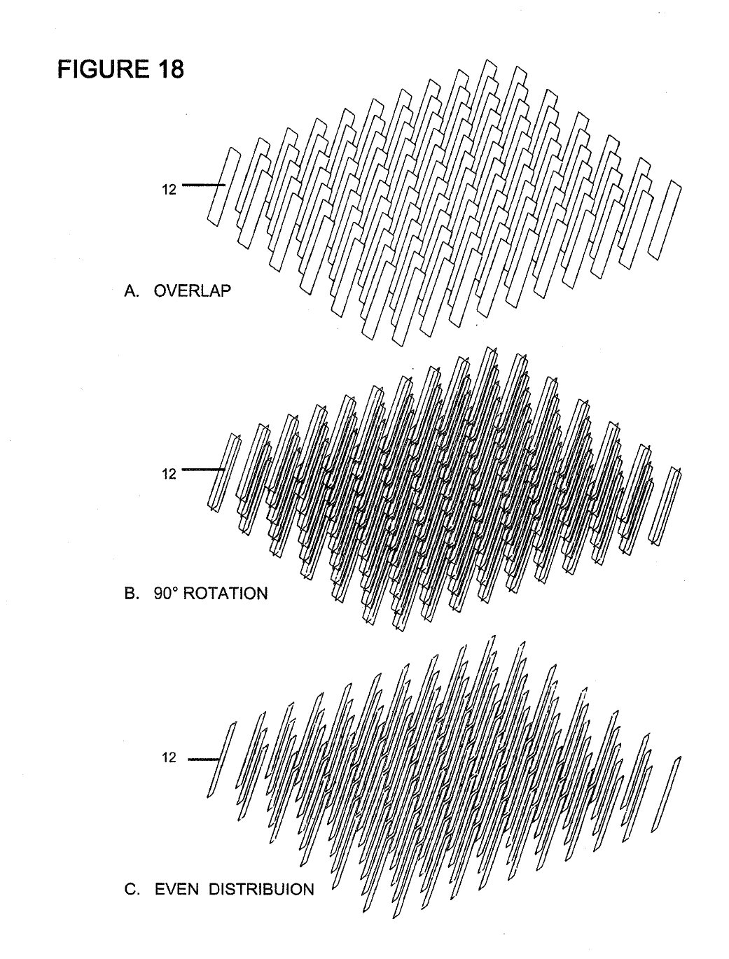

FIGS. 18A-C demonstrate the function of rotation to avoid overlap and shadowing by adjacent photopanels to improve light distribution of direct sun beams. Each figure represents an array of 120 photopanels evenly distributed spatially. The viewer's visual sight is in the same perspective or direction as the incident direct sun beams.

In FIG. 18A is shown an array of 120 photopanels 12 arrayed in an overlapping configuration. More than half of the front face of each photopanel is obscured by the adjacent photopanels in front.

In FIG. 18B is shown the same array of 120 photopanels 12, demonstrating the difference with 90° rotation along the central vertical axis of each photopanel 12 with the starting and ending configurations superimposed to depict the rotation.

In FIG. 18C is shown the same array of 120 photopanels 12 completely without overlap or shading from adjacent photopanels, after 90° rotation of each photopanel from FIG. 18A configuration. All portions of a single photopanel experience the same even exposure to direct sun beam, albeit now with a shallow light angle, necessitating described features of the hollow trabeculae as described in FIG. 17.

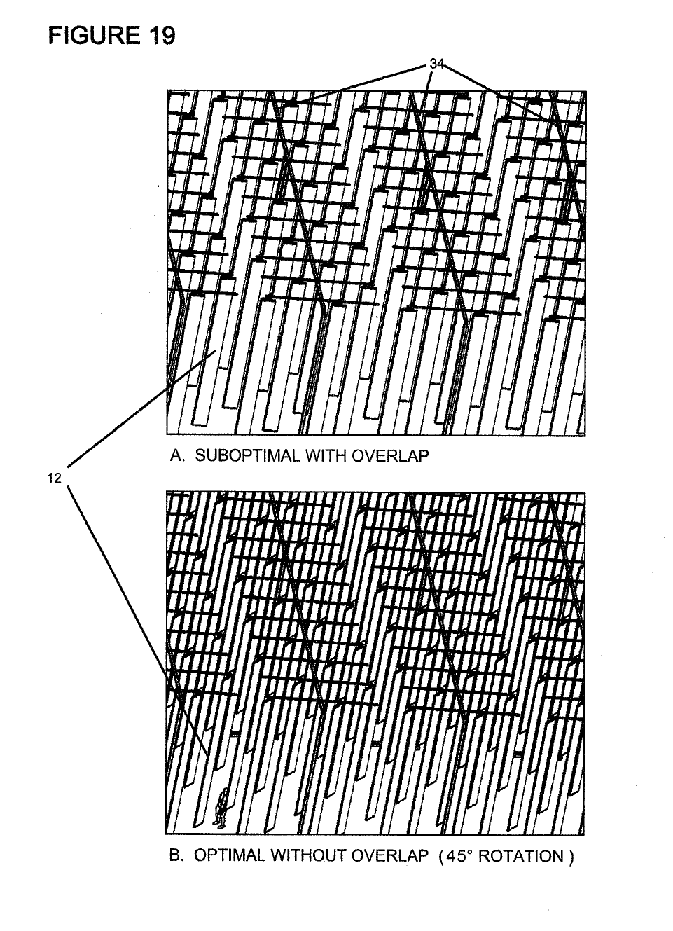

FIGS. 19A-B depict a 3 dimensional representation of rack deployment configurations of some embodiments of the device of FIGS. 4 and 5, translated into an even spatial distribution. The figures also demonstrate benefit of rotation to avoid overlap and shading from adjacent photopanels.

In FIG. 19A is shown similar to FIG. 18A, but with photopanels 12 suspended from photopanel racks 34. Substantial overlap or shading from adjacent photopanel is again represented, similar to FIG. 18A.

In FIG. 19B is shown similar to FIG. 18C, but with photopanel 12 suspended from photopanel racks, 34. In this example, a 45° rotation completely avoids the overlap and shadowing by adjacent photopanels. This allows even distribution of direct light throughout every portion of each single photopanel. This illustration demonstrates complete utilization of direct light with minimal penetration of direct light to the ground. If the direct light is excessive, e.g. mid-day, further rotation would increase the shallowness of the incident direct sun light on each photopanel, with increased space between photopanels, thereby allowing the direct sun light to strike ground and to scatter.

FIGS. 20A-C depict 3 dimensional representation of the deployment rack system similar to that illustrated in FIGS. 4 and 5.

In FIG. 20A is shown a tight or dense photopanel configuration, creating access corridors. Photopanels 12 are arrayed tightly along a rack or suspension apparatus 34 near to a central axis. This configuration creates central access corridors through which a maintenance individual 777 may conveniently pass to access an interior photopanel.

In FIG. 20B is shown an alternate view of the tight or dense photopanel configuration of FIG. 21A.,

In FIG. 20C is shown an open photopanel configuration. Photopanels 12 are translated from the tight configuration in FIG. 20A and in FIG. 20B into a spatially even distribution for even collection of scattered sunlight during day time. Substantial overlap or shading from adjacent photopanels is depicted, with uneven distribution of direct sun beam expected. Consideration for direct light beam may not be necessary during cloudy days.

The method and apparatus for the system herein, represents a new and improved system to scale up algae production into industrial quantities which employs novel vertically-oriented photosynthetic photobioreactors or photopanels and method of culture and deployment strategy.

The disclosed system optimizes the available solar energy for photosynthesis through the distribution of solar irradiance over a dramatically expanded surface area whereby the solar intensity is reduced toward or into optimal intensity range for algal photosynthesis. The disclosed photopanel device is highly adaptable to accommodate the diversity of algae strains, as well as geographic and seasonal variation utilizing common inexpensive and recyclable material. The disclosed photopanel design is especially adaptable for suspended as well as adherent algal cultures for the purpose of producing algal oil for use as biofuel. The new disclosed photopanel design addresses very specific nearly mutually exclusive culture needs for algal replication vs. algal fatty acid synthesis in the same continuous culture with ultra-high cell concentrations.

Although the above described apparatus, methods, and features are advantageously applicable to the production of algal cultures in photobioreactors, the principles may be applied to other light dependent reactions as well. Such other applications may be biological in nature such as cell constituent or protein molecule processing or other biochemical reactions, or may involve organic or inorganic chemical reactions, such as compound synthesis.

As defined herein, a ‘shallow grazing angle’ is an angle of less than 30° between the broadly defined surface of a photopanel and a ray of incipient light. Higher light angles may be applicable and preferred depending upon spacing and thickness of the photopanels, i.e. greater the distance between evenly deployed photopanels may require higher light angles to completely utilize available direct sun light. The thicker the photopanel or greater the photopanel volume allow utilization of more direct light to each photopanel.

As defined herein, a maintenance individual is an individual unit, such as a person or machine that accesses a component of a photopanel deployment system.

While all the fundamental characteristics and features of the vertically disposed device and method for algae growth been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the claims.

What is claimed is:

1. A photobioreactor deployment system comprising one or more supports configured to translate a plurality of deployed photobioreactors into different spatial distributions.

2. The photobioreactor deployment system according to claim 1, wherein a dense spatial configuration forms corridors to provide ease of access on interior photobioreators and a less dense spatial configuration for more even collection of sun light.

3. The photobioreactor deployment system according to claim 1, wherein the one or more supports allow rotation of the plurality of photobioreactors to control the amount of irradiation exposed to the photobioreactors.

4. The photobioreactor deployment system according to claim 3, wherein configuration of said system allows uniform illumination of said photobioreactors.

5. A photobioreactor deployment system according to claim 3, wherein a configuration of the photobioreactor allows collection or utilization of incident direct light with shallow grazing angles without overlap or shading by adjacent photobioreactors.

6. The photopanel deployment system of claim 5, wherein the photopanels allow direct entry of at least some light encountered at a shallow grazing angle into an interior of said photopanels.

7. The photopanel deployment system of claim 5, wherein the photopanels redirect at least some light encountered at a shallow grazing angle into an interior of said photopanels.

8. The photopanel deployment system of claim 5, wherein the photopanels reflect at least some light encountered at a shallow grazing angle such that said light is available for a photochemical reaction housed in a second photopanel.

9. The photopanel deployment system of claim 3, further comprising a light sensor or sensor system.

10. The photopanel deployment system of claim 3, wherein said translation and said rotation is automated.

11. A method of deploying a photopanel system comprising the steps of configuring said photopanels in a first configuration such that said system is more easily accessed, and configuring said deployment system in a second configuration such that light is more evenly distributed throughout said photopanel system.

12. The method of claim 11, wherein said photopanels are suspended from at least one support.

13. The method of claim 11, wherein said configuring comprises translating at least one of said photopanels along a support.

14. The method of claim 11, wherein said configuring comprises rotating at least one of said photopanels.

15. A photobioreactor deployment system comprising:
one or more supports;
a plurality of photopanels that can be attached to said supports;
a photopanel translator that allows translation of said photopanels along said supports;
a photopanel rotator that allows rotation of said photopanels about a connection point of each photopanel to a support;
a light sensor system; and
an automated device that can translate and rotate said photopanels.
